(19) United States
(12) Patent Application Publication
(10) Pub. No.: US 2026/0004440 A1
(43) Pub. Date: Jan. 1, 2026

(54) 3D MEASUREMENTS OF 2D INTRAORAL IMAGES

(71) Applicant: Align Technology, Inc., San Jose, CA (US)

(72) Inventors: Ran Katz, Hod Hasharon (IL); Moti Ben Dov, Tel Mond (IL); Liat Sivan, Tel Aviv (IL)

(21) Appl. No.: 19/236,870

(22) Filed: Jun. 12, 2025

Related U.S. Application Data
(60) Provisional application No. 63/665,207, filed on Jun. 27, 2024.

(51) Int. Cl. G06T 7/33; A61C 9/00; A61C 13/34; G06T 7/00; G06T 7/73; G06T 15/20

(52) U.S. Cl. CPC G06T 7/344; A61C 9/0053; A61C 13/34; G06T 7/0016; G06T 7/75; G06T 15/205; G06T 2200/24; G06T 2207/10024; G06T 2207/10048; G06T 2207/10064; G06T 2207/20081; G06T 2207/20084; G06T 2207/20101; G06T 2207/30036; G06T 2207/30096

(57) ABSTRACT

Methods and systems are described that generate three-dimensional (3D) measurements from points in two-dimensional (2D) images. An example method includes determining an alignment between a 2D image of a dental site and a 3D surface of the dental site, determining a first point and a second point in the 2D image, projecting the first point and the second point onto the 3D surface based on the alignment between the 2D image and the 3D surface, performing a measurement of a distance between the projected first point and the projected second point on the 3D surface, and displaying at least one of a) a first visualization of the measurement on the 2D image or b) a second visualization of the measurement on the 3D surface.

### RELATED APPLICATIONS

The present application claims the benefit under 35 U.S.C. § 119 (e) of U.S. Provisional Patent Application No. 63/665,207 filed Jun. 27, 2024, which is incorporated by reference herein.

### TECHNICAL FIELD

Embodiments of the present disclosure relate to the field of dentistry and, in particular, to three-dimensional (3D) measurements performed using two-dimensional (2D) intraoral images.

### BACKGROUND

Multiple different types of image data may be gathered to assess a patient's oral health. Such image data may include intraoral scans usable to generate 3D models of the patient's dental arches, 2D color intraoral images, 2D near infrared (NIR) intraoral images, bite-wing x-ray images, panoramic x-ray images, periapical x-ray images, and/or cone-beam computed tomography (CBCT) scans, for example. For captured 2D image data, measurements of objects in the 2D image data may not be accurate because the imaged object is a 3D object but the measurement is performed in 2D.

### SUMMARY

Multiple example implementations are summarized. Many other implementations are also envisioned.

In a first implementation, a method comprises: determining an alignment between a two-dimensional (2D) image of a dental site and a three-dimensional (3D) surface of the dental site; determining a first point and a second point in the 2D image; projecting the first point and the second point onto the 3D surface based on the alignment between the 2D image and the 3D surface; performing a measurement of a distance between the projected first point and the projected second point on the 3D surface; and displaying at least one of a) a first visualization of the measurement on the 2D image or b) a second visualization of the measurement on the 3D surface.

In a second implementation, a method comprises: determining a first alignment between a first two-dimensional (2D) image of a dental site and a three-dimensional (3D) surface of the dental site; determining a second alignment between a second two-dimensional (2D) image of the dental site and the 3D surface of the dental site; determining a first point in the first 2D image; projecting the first point onto the 3D surface based on the first alignment; determining a second point in the second 2D image; projecting the second point onto the 3D surface based on the second alignment; performing a measurement of a distance between the projected first point and the projected second point on the 3D surface; and displaying at least one of a) a first visualization of the measurement on the first 2D image, b) a second visualization of the measurement on the second 2D image, or c) a third visualization of the measurement on the 3D surface.

### BRIEF DESCRIPTION OF THE DRAWINGS

Embodiments of the present disclosure are illustrated by way of example, and not by way of limitation, in the figures of the accompanying drawings.

FIG. 1 illustrates one embodiment of a system for performing intraoral scanning and/or generating a 3D surface of an intraoral site.

FIG. 2A illustrates a flow diagram for a method of performing operations based on a correspondence between a 3D surface of a dental site and a 2D image of the dental site, in accordance with an embodiment.

FIG. 2B illustrates a flow diagram for a method of performing a 3D measurement of points in a 2D image, in accordance with an embodiment.

FIG. 2C illustrates a flow diagram for a method of performing a 3D measurement of points in multiple 2D images, in accordance with an embodiment.

FIG. 3 illustrates a flow diagram for a method of mapping 2D images of a dental site to a 3D surface of the dental site and using the mapping to perform 3D measurements, in accordance with an embodiment.

FIG. 4A illustrates a flow diagram for a method of showing a previously generated measurement of a dental site on a new 3D surface of the dental site, in accordance with an embodiment.

FIG. 4B illustrates a flow diagram for a method of tracking changes to a dental site over time, in accordance with an embodiment.

FIG. 4C illustrates a flow diagram for a method of tracking changes to a dental site over time, in accordance with an embodiment.

FIG. 4D illustrates a flow diagram for a method of selecting a 2D image that best shows a feature of a dental site, in accordance with an embodiment.

FIG. 5 illustrates a flow diagram for method of updating a 3D measurement generated based on points selected in a 2D image, in accordance with an embodiment.

FIG. 6 illustrates a flow diagram for a method of showing a measurement associated with a first 2D image on a second 2D image, in accordance with an embodiment.

FIG. 7 illustrates a flow diagram for a method of generating a measurement in a clinical plane, in accordance with an embodiment.

FIG. 8A illustrates a relationship between points on a 3D surface and corresponding points on a 2D image of the 3D surface, in accordance with an embodiment.

FIG. 8B illustrates a relationship between points on a 3D surface and corresponding points on a first and second 2D image of the 3D surface, in accordance with an embodiment.

FIG. 9 illustrates a block diagram of an example computing device, in accordance with embodiments of the present disclosure.

### DETAILED DESCRIPTION

Described herein are methods and systems of using correspondence between 2D images of a dental site and a 3D surface of the dental site to determine 3D measurements of points selected in the 2D images. 2D images of a dental site may include additional information not available in a 3D surface of the dental site (e.g., such as a 3D surface generated from intraoral scanning of the dental site). For example, a 2D image may be a near infrared (NIR) 2D image, a 2D image generated using fluorescence imaging, a 2D color image, etc. that contains information not shown in the 3D surface. A doctor may select points showing some feature, region, area of interest (AOI), etc. in a 2D image in order to make a measurement. Such a feature/region/AOI may not be visible in the 3D surface and thus it may be difficult to assess the feature/region/AOI on the 3D surface. However, measurements made in 2D may not reflect a true value of a size of the measured feature, region, AOI etc. in the real world since it does not account for differences in depth between the points. Accordingly, embodiments provide techniques for selecting points to be measured in 2D images in which features/AOIs/regions are visible, but performing measurements of the selected points on a 3D surface for accuracy.

In embodiments, a doctor or other user may select points of interest in a 2D image of a dental site, and based on a correlation (e.g., registration) between the 2D image of the dental site and a 3D surface of the dental site, the selected points may be projected onto the 3D surface. A measurement may then be made between the projected points to determine a 3D measurement value between the selected points. This enables points to be selected in a 2D image, but for the returned measurement value to be a measurement in 3D space.

In some embodiments, measurements in the 2D image may be measurements in units of digital measurement (e.g., measurements in pixels). However, the 3D surface may be an accurate 3D surface (e.g., a 3D model of the dental site that has been constructed from multiple intraoral scans of the dental site) that includes physical units of measurement. Accordingly, based on the correlation (e.g., registration) between the 2D image and the 3D surface, the 3D measurement value may be determined in units of physical measurement, such as mm, inches, and so on. Determined 3D measurements may be displayed on the 3D surface and/or may be projected back to the 2D image for display on the 2D image.

In some embodiments, a first point may be selected on a first image and a second point may be selected on a second image. Both the first image and second image may be registered to the 3D surface, and the first point may be projected from the first image to the 3D surface and the second point may be projected from the second image to the 3D surface. A measurement may then be made between the projected points on the 3D surface, and the points and/or the measurement may be projected back to the first image and/or the second image for display thereon. This enables measurements to be made between points of features/AOIs/regions of a dental site that might not all be visible in a single 2D image.

Various embodiments are described herein. It should be understood that these various embodiments may be implemented as stand-alone solutions and/or may be combined. Accordingly, references to an embodiment, or one embodiment, may refer to the same embodiment and/or to different embodiments. Additionally, some embodiments are discussed with reference to restorative dentistry and/or to corrective dentistry (orthodontics). However, it should be understood that embodiments discussed with reference to restorative dentistry (e.g., prosthodontics) may also apply to corrective dentistry (e.g., orthodontia), and embodiments discussed with reference to corrective dentistry may also apply to restorative dentistry.

Some embodiments are discussed herein with reference to intraoral scans and intraoral images. However, it should be understood that embodiments described with reference to intraoral scans also apply to lab scans or model/impression scans. A lab scan or model/impression scan may include one or more images of a dental site or of a model or impression of a dental site, which may or may not include height maps, and which may or may not include color images. In embodiments a machine learning model may be trained to identify a margin line from images of a lab scan of model/impression scan, for example.

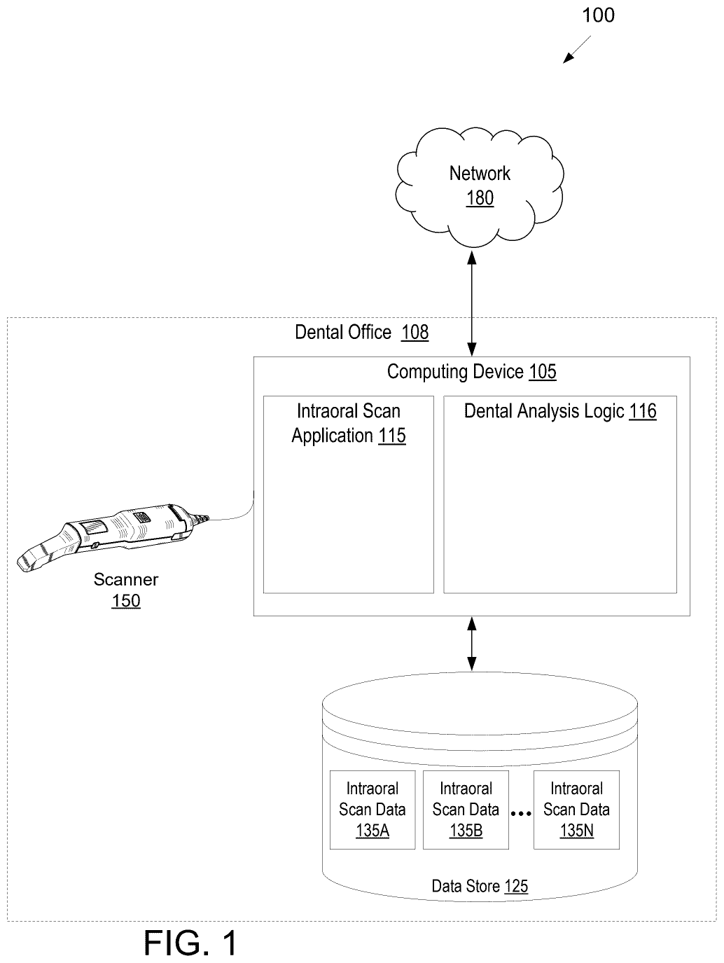

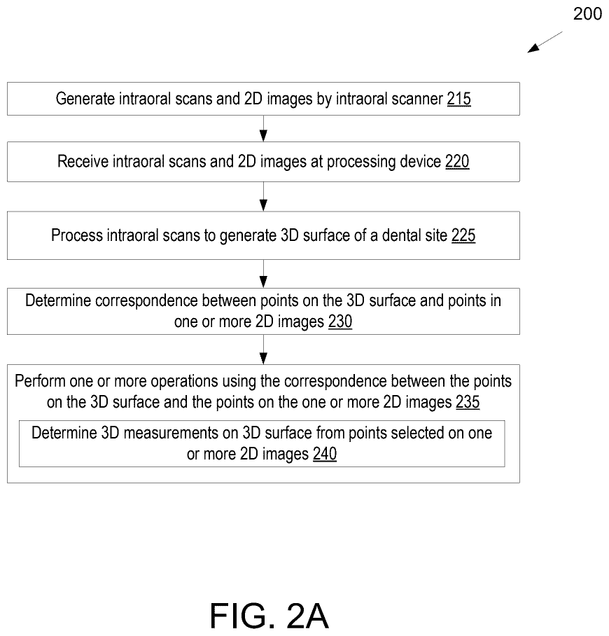

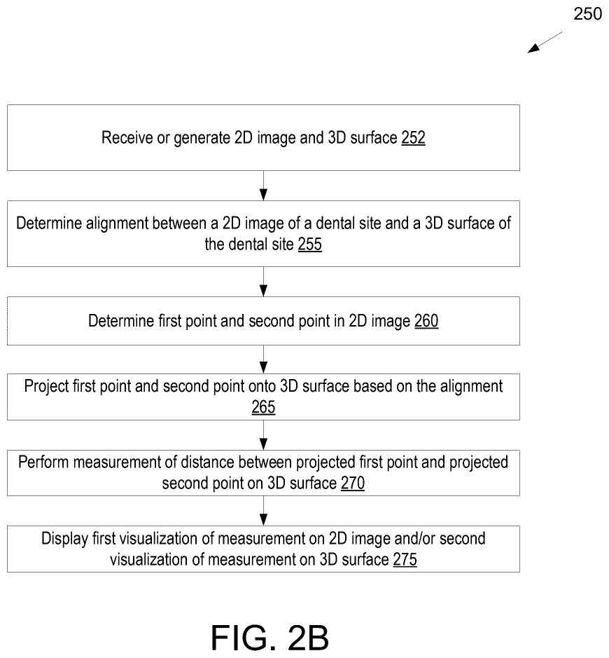

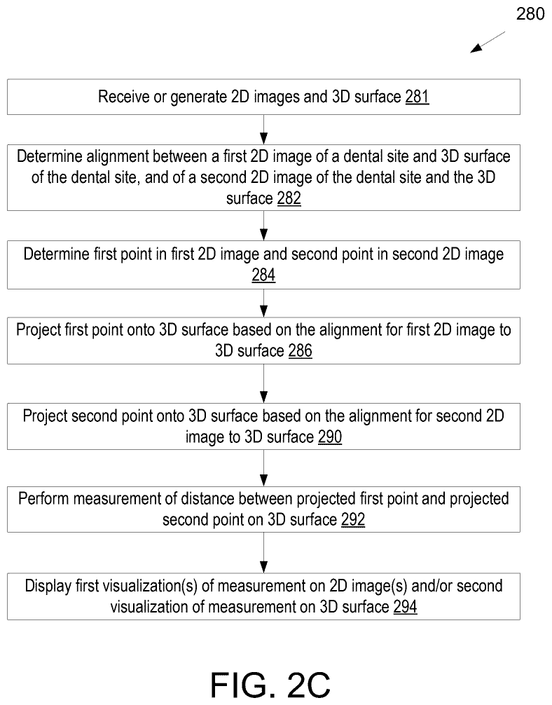

FIG. 1 illustrates one embodiment of a system 100 for performing intraoral scanning and/or generating a virtual three-dimensional model and/or surface of an intraoral site, and for generating measurements of features, regions, AOIs, and so on with respect to the 3D model and/or 2D images. In one embodiment, one or more components of system 100 carries out one or more operations described below with reference to FIGS. 2A-7.

System 100 may include a dental office 108. The dental office 108 may include a computing device 105, where the computing device 105 may be connected to one or more other devices (e.g., servers, etc.) via a network 180. The network 180 may be a local area network (LAN), a public wide area network (WAN) (e.g., the Internet), a private WAN (e.g., an intranet), or a combination thereof.

Computing device 105 may be coupled to an intraoral scanner 150 (also referred to as a scanner) and/or a data store 125. Computing device 106 may also be connected to a data store (not shown). The data stores may be local data stores and/or remote data stores. Computing device 105 and computing device 106 may each include one or more processing devices, memory, secondary storage, one or more input devices (e.g., such as a keyboard, mouse, tablet, and so on), one or more output devices (e.g., a display, a printer, etc.), and/or other hardware components.

In one embodiment, scanner 150 is wirelessly connected to computing device 105 via a direct wireless connection. In one embodiment, scanner 150 is wirelessly connected to computing device 105 via a wireless network. In one embodiment, the wireless network is a Wi-Fi network. In one embodiment, the wireless network is a Bluetooth network, a Zigbee network, or some other wireless network. In one embodiment, the wireless network is a wireless mesh network, examples of which include a Wi-Fi mesh network, a Zigbee mesh network, and so on. In an example, computing device 105 may be physically connected to one or more wireless access points and/or wireless routers (e.g., Wi-Fi access points/routers). Intraoral scanner 150 may include a wireless module such as a Wi-Fi module, and via the wireless module may join the wireless network via the wireless access point/router.

In embodiments, scanner 150 includes an inertial measurement unit (IMU). The IMU may include an accelerometer, a gyroscope, a magnetometer, a pressure sensor and/or other sensor. For example, scanner 150 may include one or more micro-electromechanical system (MEMS) IMU. The IMU may generate inertial measurement data (referred to herein as movement data or motion data), including acceleration data, rotation data, and so on.

Intraoral scanner 150 may include a probe (e.g., a hand held probe) for optically capturing three-dimensional structures. The intraoral scanner 150 may be used to perform an intraoral scan of a patient's oral cavity. An intraoral scan application 115 running on computing device 105 may communicate with the scanner 150 to effectuate the intraoral scan. A result of the intraoral scan may be intraoral scan data 135A, 135B through 135N that may include one or more sets of intraoral scans. Each intraoral scan may include a two-dimensional (2D) image that includes depth information (e.g., via a height map of a portion of a dental site) and/or may include a 3D point cloud. In either case, each intraoral scan includes x, y and z information. Some intraoral scans, such as those generated by confocal scanners, include 2D height maps. In one embodiment, the intraoral scanner 150 generates numerous discrete (i.e., individual) intraoral scans. Sets of discrete intraoral scans may be merged into a smaller set of blended intraoral scans, where each blended intraoral scan is a combination of multiple discrete intraoral scans. Intraoral scan data 135A-N may optionally include one or more color images (e.g., color 2D images) and/or images generated under particular lighting conditions (e.g., 2D ultraviolet (UV) images, 2D infrared (IR) images, 2D near-IR (NIR) images, 2D images generated using fluorescence imaging, and so on).

In some embodiments, scanner 150 alternates between capturing intraoral scans and one or more types of 2D images, such as color 2D images, NIR images, UV images, images generated using fluorescence imaging, and so on. Each of the types of 2D images may provide different useful information. The intraoral scans may be used to determine relative position and orientation of scanner 150 relative to the dental site (e.g., oral structures), and the relative position and orientation determined from the intraoral scans may be used to infer relative position and orientation of the scanner relative to the dental site at the times that 2D images were taken. This may be used to facilitate registration of the 2D images to a 3D surface generated from intraoral scans in embodiments.

In an example, NIR 2D images and/or infrared 2D images may show internal tooth structure (e.g., including dentin, enamel, pulp, etc.), caries, demineralization of teeth, cracks and/or fractures, and so on. NIR 2D images may be particularly useful in identifying caries in embodiments, as NIR imaging may be sensitive to changes in a tooth's mineral content, making it useful for detection of early stages of dental caries. Fluorescence imaging may similarly be used to detect caries (e.g., early demineralization of enamel). Additionally, fluorescence imaging may be used to show plaque and tartar, acid-producing bacteria, oral lesions, and so on. In another example, color 2D images may show tooth stains, gum inflammation (e.g., redness), oral lesions (e.g., such as ulcers, sores, cancers, etc.), plaque and tartar, and so on.

The scanner 150 may transmit the intraoral scan data 135A, 135B through 135N to the computing device 105. Computing device 105 may store the intraoral scan data 135A-135N in data store 125.

According to an example, a user (e.g., a practitioner) may subject a patient to intraoral scanning. In doing so, the user may apply scanner 150 to one or more patient intraoral locations. The scanning may be divided into one or more segments. As an example, the segments may include an upper dental arch segment, a lower dental arch segment, a bite segment, and optionally one or more preparation tooth segments. As another example, the segments may include a lower buccal region of the patient, a lower lingual region of the patient, an upper buccal region of the patient, an upper lingual region of the patient, one or more preparation teeth of the patient (e.g., teeth of the patient to which a dental device such as a crown or other dental prosthetic will be applied), one or more teeth which are contacts of preparation teeth (e.g., teeth not themselves subject to a dental device but which are located next to one or more such teeth or which interface with one or more such teeth upon mouth closure), and/or patient bite (e.g., scanning performed with closure of the patient's mouth with the scan being directed towards an interface area of the patient's upper and lower teeth). Via such scanner application, the scanner 150 may provide intraoral scan data 135A-N to computing device 105. The intraoral scan data 135A-N may be provided in the form of intraoral scan data sets, each of which may include 3D point clouds, 2D images and/or 3D images of particular teeth and/or regions of an intraoral site. In one embodiment, separate data sets are created for the maxillary arch, for the mandibular arch, for a patient bite, and for each preparation tooth. Alternatively, a single large data set is generated (e.g., for a mandibular and/or maxillary arch). Such scans may be provided from the scanner 150 to the computing device 105 in the form of one or more points (e.g., one or more point clouds).

The manner in which the oral cavity of a patient is to be scanned may depend on the procedure to be applied thereto. For example, if an upper or lower denture is to be created, then a full scan of the mandibular or maxillary edentulous arches may be performed. In contrast, if a bridge is to be created, then just a portion of a total arch may be scanned which includes an edentulous region, the neighboring preparation teeth (e.g., abutment teeth) and the opposing arch and dentition. Additionally, the manner in which the oral cavity is to be scanned may depend on a doctor's scanning preferences and/or patient conditions. For example, some doctors may perform an intraoral scan (e.g., in a standard preparation scanning mode) after using a retraction cord to expose a margin line of a preparation. Other doctors may use a partial retraction scanning technique in which only portions of the margin line are exposed and scanned at a time (e.g., performing a scan in a partial retraction scanning mode).

By way of non-limiting example, dental procedures may be broadly divided into prosthodontic (restorative) and orthodontic procedures, and then further subdivided into specific forms of these procedures. Additionally, dental procedures may include identification and treatment of gum disease, sleep apnea, and intraoral conditions. The term prosthodontic procedure refers, inter alia, to any procedure involving the oral cavity and directed to the design, manufacture or installation of a dental prosthesis at a dental site within the oral cavity (intraoral site), or a real or virtual model thereof, or directed to the design and preparation of the intraoral site to receive such a prosthesis. A prosthesis may include any restoration such as crowns, veneers, inlays, onlays, implants and bridges, for example, and any other artificial partial or complete denture. The term orthodontic procedure refers, inter alia, to any procedure involving the oral cavity and directed to the design, manufacture or installation of orthodontic elements at a intraoral site within the oral cavity, or a real or virtual model thereof, or directed to the design and preparation of the intraoral site to receive such orthodontic elements. These elements may be appliances including but not limited to brackets and wires, retainers, clear aligners, or functional appliances.

For many prosthodontic procedures (e.g., to create a crown, bridge, veneer, etc.), a preparation tooth is created (e.g., by grinding a portion of a tooth to a stump). The preparation tooth has a margin line that can be important to proper fit of a dental prosthesis. After the preparation tooth is created, a practitioner performs operations to ready that preparation tooth for scanning. Readying the preparation tooth for scanning may include wiping blood, saliva, etc. off of the preparation tooth and/or separating a patient's gum from the preparation tooth to expose the margin line.

During intraoral scanning, intraoral scan application 115 may register and stitch together two or more intraoral scans (e.g., intraoral scan data 135A and intraoral scan data 135B) generated thus far from the intraoral scan session. In one embodiment, performing registration includes capturing 3D data of various points of a surface in multiple scans, and registering the scans by computing transformations between the scans. One or more 3D surfaces may be generated based on the registered and stitched together intraoral scans during the intraoral scanning. The one or more 3D surfaces may be output to a display so that a doctor or technician can view their scan progress thus far.

As each new intraoral scan is captured and registered to previous intraoral scans and/or a 3D surface, the one or more 3D surfaces may be updated, and the updated 3D surface(s) may be output to the display. In embodiments, segmentation is performed on the intraoral scans and/or the 3D surface to segment points and/or patches on the intraoral scans and/or 3D surface into one or more classifications. In one embodiment, intraoral scan application 115 classifies points as hard tissue or as soft tissue. The 3D surface may then be displayed using the classification information. For example, hard tissue may be displayed using a first visualization (e.g., an opaque visualization) and soft tissue may be displayed using a second visualization (e.g., a transparent or semi-transparent visualization).

In embodiments, separate 3D surfaces are generated for the upper jaw and the lower jaw. This process may be performed in real time or near-real time to provide an updated view of the captured 3D surfaces during the intraoral scanning process.

When a scan session or a portion of a scan session associated with a particular scanning role or segment (e.g., upper jaw role, lower jaw role, bite role, etc.) is complete (e.g., all scans for an intraoral site or dental site have been captured), intraoral scan application 115 may automatically generate a virtual 3D model of one or more scanned dental sites (e.g., of an upper jaw and a lower jaw), where the 3D model is a 3D surface having increased accuracy. The final 3D model may be a set of 3D points and their connections with each other (i.e., a mesh). In some embodiments, the final 3D model is a volumetric 3D model that has both surface and internal features. In embodiments, the 3D model is a volumetric model generated as described in International Publication No. WO2019147984, filed Jan. 25, 2019 and published Aug. 1, 2019, which is incorporated by reference herein in its entirety.

To generate the virtual 3D model, intraoral scan application 115 may register and stitch together the intraoral scans generated from the intraoral scan session that are associated with a particular scanning role or segment. The registration performed at this stage may be more accurate than the registration performed during the capturing of the intraoral scans, and may take more time to complete than the registration performed during the capturing of the intraoral scans. In one embodiment, performing scan registration includes capturing 3D data of various points of a surface in multiple scans, and registering the scans by computing transformations between the scans. The 3D data may be projected into a 3D space of a 3D model to form a portion of the 3D model. The intraoral scans may be integrated into a common reference frame by applying appropriate transformations to points of each registered scan and projecting each scan into the 3D space.

In one embodiment, registration is performed for adjacent or overlapping intraoral scans (e.g., each successive frame of an intraoral video). In one embodiment, registration is performed using blended scans. Registration algorithms are carried out to register two adjacent or overlapping intraoral scans (e.g., two adjacent blended intraoral scans) and/or to register an intraoral scan with a 3D model, which essentially involves determination of the transformations which align one scan with the other scan and/or with the 3D model. Registration may involve identifying multiple points in each scan (e.g., point clouds) of a scan pair (or of a scan and the 3D model), surface fitting to the points, and using local searches around points to match points of the two scans (or of the scan and the 3D model). For example, intraoral scan application 115 may match points of one scan with the closest points interpolated on the surface of another scan, and iteratively minimize the distance between matched points. Other registration techniques may also be used.

Intraoral scan application 115 may repeat registration for all intraoral scans of a sequence of intraoral scans to obtain transformations for each intraoral scan, to register each intraoral scan with previous intraoral scan(s) and/or with a common reference frame (e.g., with the 3D model). Intraoral scan application 115 may integrate intraoral scans into a single virtual 3D model by applying the appropriate determined transformations to each of the intraoral scans. Each transformation may include rotations about one to three axes and translations within one to three planes.

In many instances, data from one or more intraoral scans does not perfectly correspond to data from one or more other intraoral scans. Accordingly, in embodiments intraoral scan application 115 may process intraoral scans (e.g., which may be blended intraoral scans) to determine which intraoral scans (or which portions of intraoral scans) to use for portions of a 3D model (e.g., for portions representing a particular dental site). Intraoral scan application 115 may use data such as geometric data represented in scans and/or time stamps associated with the intraoral scans to select optimal intraoral scans to use for depicting a dental site or a portion of a dental site (e.g., for depicting a margin line of a preparation tooth).

Additionally, or alternatively, intraoral scans may be assigned weights based on scores assigned to those scans (e.g., based on proximity in time to a time stamp of one or more selected 2D images). Assigned weights may be associated with different dental sites. In one embodiment, a weight may be assigned to each scan (e.g., to each blended scan) for a dental site (or for multiple dental sites). During model generation, conflicting data from multiple intraoral scans may be combined using a weighted average to depict a dental site. The weights that are applied may be those weights that were assigned based on quality scores for the dental site. For example, processing logic may determine that data for a particular overlapping region from a first set of intraoral scans is superior in quality to data for the particular overlapping region of a second set of intraoral scans. The first intraoral scan data set may then be weighted more heavily than the second intraoral scan data set when averaging the differences between the intraoral scan data sets. For example, the first intraoral scans assigned the higher rating may be assigned a weight of 70% and the second intraoral scans may be assigned a weight of 30%. Thus, when the data is averaged, the merged result will look more like the depiction from the first intraoral scan data set and less like the depiction from the second intraoral scan data set.

In one embodiment, images and/or intraoral scans are input into a machine learning model that has been trained to select and/or grade images and/or intraoral scans of dental sites. In one embodiment, one or more scores are assigned to each image and/or intraoral scan, where each score may be associated with a particular dental site and indicate a quality of a representation of that dental site in the 2D image and/or intraoral scan. Once a set of images is selected for use in generating a portion of a 3D model/surface that represents a particular dental site (or a portion of a particular dental site), those images/scans and/or portions of those images/scans may be locked. Locked images or portions of locked images that are selected for a dental site may be used exclusively for creation of a particular region of a 3D model (e.g., for creation of the associated tooth in the 3D model).

Intraoral scan application 115 may generate one or more 3D surfaces and/or 3D models from intraoral scans, and may display the 3D surfaces generated during intraoral scanning and/or 3D models generated during or after intraoral scanning (referred to collectively as 3D surfaces) to a user (e.g., a doctor) via a user interface. The 3D surfaces can then be checked visually by the doctor. The doctor can virtually manipulate the 3D surfaces via the user interface with respect to up to six degrees of freedom (i.e., translated and/or rotated with respect to one or more of three mutually orthogonal axes) using suitable user controls (hardware and/or virtual) to enable viewing of the 3D surface from any desired direction. The doctor may review (e.g., visually inspect) the generated 3D surface of an intraoral site and determine whether the 3D surface is acceptable (e.g., whether a margin line of a preparation tooth is accurately represented in the 3D surface).

Once a 3D model of a dental site (e.g., of a dental arch or a portion of a dental arch including a preparation tooth) is generated, the 3D model and/or 2D images associated with the 3D model may be processed by a dental analysis logic 116 for review and/or analysis. Additionally, or alternatively, one or more operations associated with review and/or analysis of the 3D model, the 2D image(s) and/or a 3D surface generate during intraoral scanning may be performed by intraoral scan application 115. Accordingly, in embodiments intraoral scan application 115 may include a copy of dental analysis logic 116.

Dental analysis logic 116 may include a graphical user interface (GUI) in which one or more 2D images are presented. A user may scroll through available 2D images to find a 2D image of interest. In some instances, a user may move and/or rotate a 3D surface (or a window associated with a view of the 3D surface), and one or more 2D images most closely aligned with a current view of the 3D surface may be automatically selected, as is discussed in greater detail below.

In some embodiments, processing logic automatically selects two or more points in the 2D image. For example, the 2D image may be processed by a trained machine learning model that may perform instance segmentation or semantic segmentation on the 2D image to generate segmentation information of the 2D image. The trained machine learning model may additionally select two or more points based on the segmentation information (e.g., at two points or extremes associated with a particular identified segment or object). Alternatively, or additionally, image processing may be performed on the segmented 2D image (e.g., on the segmentation information of the 2D image) to select points on the 2D image.

Once a 2D image is selected, via the user interface a doctor (or other user) may select multiple points in the 2D image. In one embodiment, two points may be selected and a distance between the two points may be computed. The two points may be selected for example, based on a user drawing a line between two points on the 2D image via a drawing tool of the GUI. Alternatively, the user may click on the two points on the 2D image to select the points. Alternatively, points may be automatically selected as described above. The dental analysis logic 116 may align the 2D image with the 3D surface (e.g., register the 2D image with the 3D surface), and based on the alignment may project the selected points onto the 3D surface. A measurement may then be made based on the projected points. The distance between the selected points on the 3D surface may be determined in units of physical measurement (e.g., mm) in embodiments.

In some embodiments, more than two points are selected. For example, a doctor may draw a shape such as a circle, an oval, a square, an ellipse, or other geometric or irregular shape. Multiple points on the shape may be automatically selected in embodiments. In one embodiment, processing logic may process a 2D image using a trained machine learning model, which may output the size and shape of a feature or ROI. Multiple points on the feature or AOI may be automatically selected by the machine learning model or based on an output of the machine learning model. Alternatively, a user may actively select multiple points. Processing logic may project each of the points onto the 3D surface, and may measure multiple distances (e.g., multiple linear distances between pairs of points). Alternatively, or additionally, processing logic may measure an area of a shape defined by the multiple points and/or a volume of the shape defined by the multiple points. The area may be an area in a plane, or an area along a contour of the 3D surface in embodiments. The computed area may be measured in units of area such as mm², and the computed volume may be measured in units of volume such as mm³ in embodiments.

In some embodiments, dental analysis logic 116 determines one or more additional 2D images and projects the measurement (e.g., the selected two or more points and the measurement associated with those points) onto the one or more additional 2D images. One or more of the additional 2D images may better show a feature, region or AOI of the dental site associated with the points. Accordingly, a size of the feature, region or AOI may be larger in one or more of the additional 2D images than in the initial 2D image on which the points were selected. In such an instance, a user may select new points from one of the additional 2D images, and those points may be projected onto the 3D surface to generate a new measurement. Alternatively, new points may be automatically selected by a trained machine learning model that receives the additional 2D image and projected points as an input and that outputs new points. The new points may be projected onto the 2D surface to generate a new measurement. The new measurement may better reflect an actual dimension or size of the feature, region or AOI being measured. The new measurement may be reflected back onto the additional 2D image, one or more additional 2D images and/or the initial 2D image in embodiments.

In some embodiments, dental analysis logic 116 stores measurements in data store 125. Measurements may be stored, for example, in a patient record for a patient associated with the 2D images and the 3D surface. At a future patient visit, a new intraoral scanning process may be performed of the patient to generate a plurality of new intraoral scans and a new 3D surface or model. The previously made measurement may be retrieved and shown on the new 3D surface and/or on one or more of the new 2D images. This may include aligning (e.g., registering) the initial 2D image and/or original 3D surface to the new 3D surface, and then projecting the points from the initial 2D image or initial 3D surface that are associated with the stored measurement onto the new 3D surface. The measurement may be projected from the new 3D surface to a new 2D image in some embodiments.

In some instances, a new 2D image may be selected (e.g., that may have a similar camera orientation and/or position relative to the dental site as the initial 2D image used to generate the initial measurement). New points may be selected either automatically or manually on the new 2D image. For example, processing logic may perform segmentation of the new 2D image. Processing logic may additionally project the originally selected points from the new 3D surface onto the new 2D image. Processing logic may then determine an object or AOI from the segmentation that is associated with the retrieved measurement (e.g., may determine that the points projected onto the new 2D image are within the AOI or object). Processing logic may then determine edges of the AOI or object that are proximate to (e.g., closest to) the points, and may select new points at the edges. Alternatively, a user may manually select new points on the new 2D image. Dental analysis logic 116 may then project the new points onto the new 3D surface and determine a new measurement from the new projected points. The new measurement may be projected back onto the new 2D image. The new measurement may be compared to the original measurement to determine changes to an AOI, region, feature, etc. of the dental site. For example, a size of a caries as measured at different patient visits may be compared to track a progression of the caries. Similarly, sizes of other AOIs, lesions, features, etc. measured from different patient visits may be compared to determine progression, worsening, improvement, etc. of one or more oral health conditions. Examples of AOIs, features, etc. that may be measured and compared between images taken at different times include caries, gingival recession at one or more teeth, tooth contours (e.g., to show tooth wear), lesions, tooth gaps, tooth cracks, and so on.

In some embodiments, dental analysis logic 116 is hosted on a remote computing device (not shown), which may be a server computing device. The remote computing device may include compute resources, storage resources, etc. hosted in a cloud computing environment in embodiments.

FIGS. 2A-7 illustrate methods related to 3D measurements of points selected in 2D images in embodiments. The methods may be performed by a processing logic that may comprise hardware (e.g., circuitry, dedicated logic, programmable logic, microcode, etc.), software (e.g., instructions run on a processing device to perform hardware simulation), or a combination thereof. In one embodiment, at least some operations of the methods are performed by a computing device executing dental analysis logic 116 of FIG. 1. For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

FIG. 2A illustrates a flow diagram for a method 200 of performing operations based on a correspondence between a 3D surface of a dental site and a 2D image of the dental site, in accordance with an embodiment.

At block 215 of method 200, an intraoral scanner generates a sequence of intraoral scans and 2D images. The intraoral scanner may alternate between generation of intraoral scans (which contain 3D information) and one or more types of 2D intraoral images. Each of the intraoral scans may therefore be associated with one or more 2D images generated close in time to when the intraoral scans were generated. The 2D images may contain more dense data (e.g., data for more points of a dental site) than a single intraoral scan in some embodiments. The 2D images may include, for example, color 2D images, NIR 2D images, 2D images generated using fluorescence imaging, 2D images generated using ultraviolet imaging, and so on. At block 220, a processing device (e.g., of a computing device) receives the intraoral scans and the 2D images.

At block 225, processing logic processes the intraoral scans to generate a 3D surface of a scanned dental site. This may include performing registration and stitching between the intraoral scans. If intraoral scanning is complete, then the 3D surface may be a virtual 3D model of the dental site.

At block 230, processing logic determines correspondence between points on the 3D surface and points in one or more 2D images. For each 2D image, a trajectory may be determined using one or more 3D scans generated before the 2D image was generated and one or more 3D scans generated after the 2D image was generated. The trajectory may then be used to interpolate a position and orientation of the 2D image and/or the camera that generated the 2D image relative to positions and orientations of points on the 3D surface (or relative to the position and orientation of the camera at the time that the intraoral scans were generated). In some embodiments, inertial measurement data (e.g., acceleration data and/or rotation data) may be generated by the IMU of the intraoral scanner, and may be used together with the interpolation to determine accurate positions and orientations associated with each 2D image. In some embodiments, registration is performed between each of the 2D images and the 3D surface. The registration may be used to determine a position and orientation of points in the 2D image relative to points on the 3D surface. Such registration may be used to determine a camera position and orientation for each 2D image and/or for each point of the 2D image. In one embodiment, a simultaneous localization and mapping (SLAM) algorithm is used to perform registration between the 2D image and the 3D surface (e.g., by comparing data from the 2D image to data from the 3D surface). In an example, registration between the 2D image and the 3D surface may be performed by finding multiple features in both the 2D image and the 3D model (possibly from multiple cameras), finding correspondence between those features, and finding a best camera position for that correspondence. In one embodiment, the technique described in Nathan Crombez et al., “Multimodal 2D Image to 3D Model Registration via a Mutual Alignment of Sparse and Dense Visual Features,” IEEE International Conference on Robotics and Automation—ICRA, 2018 May 2018, Brisbane, Australia, pp. 6316-6322, is used for registration, the contents of which are incorporated by reference herein. In one embodiment, correspondence is determined as set forth in U.S. application Ser. No. 18/366,565, filed Aug. 7, 2023, which is incorporated by reference herein in its entirety.

In embodiments, a camera position and orientation is determined for each 2D image and stored as metadata for the 2D image and/or in a separate data store and/or file (e.g., in a table of camera positions/orientations). Additionally, in embodiments a “camera model” may be determined for each camera of an intraoral scanner that is used to generate 2D images. Each camera may be associated with a different camera model, and each camera model may be assigned a unique camera model identifier (ID). For each image, an camera model ID associated with the camera that captured that image may be stored as metadata for the 2D image or in a separate data store and/or file. A “camera model” may be a pinhole model or other model which can be used to find, for each pixel in an associated 2D image, a ray corresponding to that pixel in object space. For example, a pinhole model with a distortion function or a more complicated raxel model may be used as the camera model. Camera models may be generated for cameras of an intraoral scanner during calibration of the intraoral scanner (e.g., using a specialized jig).

At block 235, processing logic performs one or more operations using the correspondence between the points on the 3D surface and the points on the one or more 2D images. In one embodiment, at block 240 processing logic determines one or more 3D measurements (e.g., measurements in 3D space) from points selected on one or more 2D images.

FIG. 2B illustrates a flow diagram for a method 250 of performing a 3D measurement of points in a 2D image, in accordance with an embodiment. At block 252 of method 250, processing logic receives or generates a 2D image of a dental site and a 3D surface of the dental site. The 3D surface may have been generated from intraoral scans generated during a same intraoral scanning session at which the 2D image was generated in some embodiments and may be a 3D model of the dental site. Alternatively, the 2D image may have been generated at a different time and/or by a different device than a device (e.g., intraoral scanner) that generated intraoral scans used to generate the 3D surface. For example, the 2D image may have been generated by a standalone digital camera, by a camera of a mobile device (e.g., of a tablet computer, of a mobile phone, etc.), by a camera connected to a computing device, by a security camera, and so on rather than an intraoral scanner. In some instances, the 3D surface may be generated from one or more 2D images rather than from intraoral scans. In such an instance, the 3D surface may not be as accurate as a 3D surface generated from intraoral scans. In some instances the 2D image is one of multiple 2D images that are together used to generate the 3D surface.

At block 255, processing logic determines an alignment between the 2D image of the dental site and the 3D surface of the dental site. Determining the alignment between the 2D image and the 3D surface may include determining correspondence between points on the 3D surface and points on the 2D image, as set forth in bock 230 of method 200, for example. The alignment or correspondence may be determined, for example, by registering the 2D image with the 3D surface.

At block 260, processing logic determines a first point and a second point in the 2D image. The first point and the second point may be selected by a user based, for example, on the user using a mouse pointer or other input device to select (e.g., click on) the points, to draw a line between the points, etc. Alternatively, the points may be automatically selected by a trained machine learning model in embodiments. For example, the machine learning model may be trained to perform segmentation to determine locations and shapes of various types of dental objects, features or oral structures, such as teeth, gingiva, dentin, caries, lesions, and so on. The machine learning model or another machine learning model may be further trained to select points on the identified dental objects, such as points at extreme regions (e.g., two furthest apart points on) one or more identified dental objects, features, oral structures, etc. In some embodiments, processing logic determines a measurement between the points in the 2D image. The determined measurement may be in units of digital measurement, such as in pixels.

At block 265, processing logic projects the first point and the second point onto the 3D surface based on the determined alignment. At block 270, processing logic performs a measurement of a distance between the projected first point and the projected second point on the 3D surface. Since the 3D surface is in 3D space that has one more dimension than the 2D space of the 2D image on which the points were selected, the distance between the points may be greater on the 3D surface than in the 2D image. In embodiments, the distance between the projected points on the 3D surface are determined in units of physical measurement, such as mm, inches, etc. The measurement may indicate, for example, a caries size, a tooth size, a spacing between teeth, a tumor size, a lesion size, an amount of gingival recession, a tooth width, or an amount that a tooth has erupted, and so on.

In one embodiment, processing logic performs a comparison of the measurement to one or more measurement criteria. The measurement criteria may include, for example, a gingival recession distance threshold, a caries size threshold, a tooth crack size threshold, a tumor size threshold, and so on. Processing logic may determine an existence of an oral condition based on the measurement satisfying a measurement criterion. Processing logic may additionally, or alternatively, determine a severity of an oral condition associated with the measurement based on the measurement satisfying a measurement criterion. For example, an oral condition such as a caries condition may have different thresholds, where each threshold represents a different severity level. If the measurement satisfies a measurement criterion associated with a particular severity level (e.g., is equal to or greater than a size threshold associated with that severity level), then processing logic may determine that the measured oral condition has the severity level associated with that measurement criterion. In embodiments, the severity level is determined based on the severity level associated with the highest measurement threshold that was met.

At block 275, processing logic may display a first visualization of the measurement on the 2D image. This may include projecting the measurement back onto the 2D image and/or showing the measurement (e.g., a measurement value in units of physical measurement) on the 2D image. Additionally, or alternatively, processing logic may display a second visualization of the measurement on the 3D surface. The measurement may additionally be stored in a datastore in embodiments.

FIG. 2C illustrates a flow diagram for an additional method 280 of performing a 3D measurement of points in a 2D image, in accordance with an embodiment. As set forth in method 250, all selected points were selected from a single image. However, measurements may also be performed on a 3D surface based on different points selected in different 2D images. For example, a first portion of an area of interest (e.g., a first side of a tooth) may be shown in a first image but not a second image. A second portion of the area of interest (e.g., a second side of the tooth) may be shown in the second image but not the first image. In some embodiments, the different images are of a same image type (e.g., both color images or both NIR images) but from different camera positions and/or angles. In some embodiments, the different images are of different image types (e.g., one color image and one NIR image) and may be taken from a same or different camera positions and/or orientations. In embodiments, different points may be selected on different 2D images, projected onto the same 3D surface, and then measured on the 3D surface.

At block 281 of method 280, processing logic receives or generates multiple 2D images of a dental site and a 3D surface of the dental site. The 3D surface may have been generated from intraoral scans generated during a same intraoral scanning session at which the 2D images were generated in some embodiments. Alternatively, the 2D images may have been generated at a different time and/or by a different device than a device (e.g., intraoral scanner) that generated intraoral scans used to generate the 3D surface. For example, the 2D images may have been generated by a standalone digital camera, by a camera of a mobile device (e.g., of a tablet computer, of a mobile phone, etc.), by a camera connected to a computing device, by a security camera, and so on rather than an intraoral scanner. In some instances, the 3D surface may be generated from one or more 2D images rather than from intraoral scans. In such an instance, the 3D surface may not be as accurate as a 3D surface generated from intraoral scans. In some instances the 2D images are a subset of multiple 2D images that are together used to generate the 3D surface.

At block 282, processing logic determines an alignment between a first 2D image of the dental site and the 3D surface of the dental site. Additionally, processing logic determines an alignment between a second 2D image of the dental site and the 3D surface of the dental site. Determining the alignment between the 2D images and the 3D surface may include determining correspondence between points on the 3D surface and points on the 2D images, as set forth in bock 230 of method 200, for example. The alignment or correspondence may be determined, for example, by registering the 2D images with the 3D surface.

At block 284, processing logic determines a first point on the first 2D image and a second point on the second 2D image. The first point and the second point may be selected by a user based, for example, on the user using a mouse pointer or other input device to select (e.g., click on) the points. Alternatively, the points may be automatically selected by a trained machine learning model in embodiments. For example, the machine learning model may be trained to perform segmentation to determine locations and shapes of various types of dental objects, features or oral structures, such as teeth, gingiva, dentin, caries, lesions, and so on. The machine learning model or another machine learning model may be further trained to select points on the identified dental objects.

At block 286, processing logic projects the first point from the first 2D image onto the 3D surface based on the determined alignment between the first 2D image and the 3D surface. At block 290, processing logic projects the second point from the second 2D image onto the 3D surface based on the determined alignment between the second 2D image and the 3D surface.

At block 292, processing logic performs a measurement of a distance between the projected first point and the projected second point on the 3D surface. In embodiments, the distance between the projected points on the 3D surface are determined in units of physical measurement, such as mm, inches, etc.

At block 294, processing logic may display a first visualization of the measurement on the first 2D image and/or second 2D image. This may include projecting the measurement and/or one or more of the points back onto the 2D image and/or showing the measurement (e.g., a measurement value in units of physical measurement) on the 2D image. Additionally, or alternatively, processing logic may display a second visualization of the measurement on the 3D surface. The measurement may additionally be stored in a datastore in embodiments.

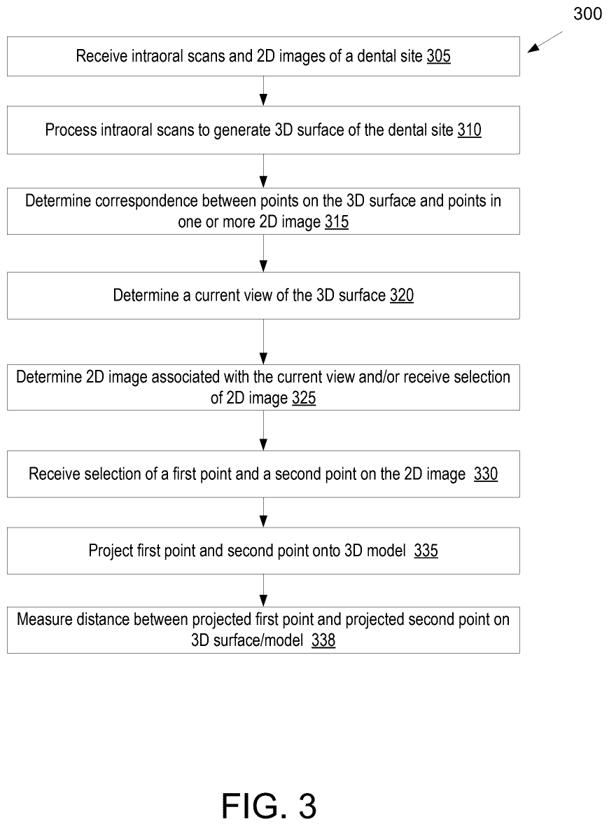

FIG. 3 illustrates a flow diagram for a method 300 of mapping 2D images of a dental site to a 3D surface of the dental site and using the mapping to perform 3D measurements, in accordance with an embodiment. At block 305, processing logic receives intraoral scans and 2D images generated by an intraoral scanner. The intraoral scanner may alternate between generation of intraoral scans (which contain 3D information) and one or more types of 2D intraoral images. The 2D images may include, for example, color 2D images, NIRI 2D images, fluorescent 2D images, ultraviolet 2D images, and so on.

At block 310, processing logic processes the intraoral scans to generate a 3D surface of a scanned dental site. This may include performing registration and stitching between the intraoral scans. If intraoral scanning is complete, then the 3D surface may be a virtual 3D model of the dental site.

At block 315, processing logic determines correspondence between points on the 3D surface and points in the 2D images. For each 2D image, a trajectory may be determined using one or more 3D scans generated before the 2D image was generated and one or more 3D scans generated after the 2D image was generated. The trajectory may then be used to interpolate a position and orientation of the 2D image and/or the camera that generated the 2D image relative to positions and orientations of points on the 3D surface (or relative to the position and orientation of the camera at the time that the intraoral scans were generated). In some embodiments, registration is performed between each of the 2D images and the 3D surface. The registration may be used to determine a position and orientation of points in the 2D image relative to points on the 3D surface. Such registration may be used to determine a camera position and orientation for each 2D image and/or for each point of the 2D image. In embodiments, a camera position and orientation is determined for each 2D image and stored as metadata for the 2D image and/or in a table of camera positions/orientations.

At block 320, processing logic may determine a current view (e.g., direction of view) of the 3D surface. Processing logic may additionally determine a selected point on the 3D surface.

At block 325, processing logic may determine one or more 2D images associated with the current view (e.g., direction of view) and/or the selected point on the 3D surface. In some embodiments, processing logic receives a user selection of a point on the 3D surface during a current view of the 3D surface. For each view of the 3D surface and selection of a point on the 3D surface, a camera position and orientation may be determined. A lookup may then be performed to determine one or more 2D image having a camera position and orientation that corresponds to or is closest to the determined camera position and orientation. Processing logic may select and display the determined 2D image or images in embodiments. Alternatively, a user may select a 2D image.

At block 325, processing logic may receive a selection of one or more 2D images. A view of the 3D surface may be output to a display as part of a graphical user interface. A user may move a cursor across the 3D surface and/or otherwise select a point on the 3D surface. As the user moves the cursor, one or more 2D image corresponding to the current view and selected point may be output to the display proximate the 3D surface or overlaid on top of the 3D surface (e.g., over a location that the 2D image registers to). At any time, a user may select a currently viewed 2D image, and that 2D image may be pinned to the display. As the user continues to move the cursor or select new points, new 2D images corresponding to the newly selected points may be shown. However, the pinned image may also continue to be shown.

In some embodiments, a panoramic image of a patient's dental site (e.g., of the patient's dental arch) may be generated based on registering and stitching together multiple 2D images captured during intraoral scanning. In some embodiments, a panoramic image is generated from multiple 2D images as described in U.S. Pat. No. 11,707,238, issued Jul. 25, 2023, which is incorporated herein in its entirety. The panoramic image may be a 2D image generated based on combining multiple other 2D images. Each point on the panoramic image may be mapped to a corresponding point on the 3D surface. A user may then select any point on the panoramic image, and processing logic may determine the corresponding point on the 3D surface and indicate the determined point on the 3D surface. Accordingly, in embodiments points may be selected from a 2D panoramic image, and a measurement on a 3D surface may be determined based on the selected points on the panoramic image.

In one embodiment, processing logic may implement one or more automated agents configured to identify the key camera angles for which to construct a panoramic model, image and/or view. In some implementations, the angle selection engine(s) is configured to generate a sphere (or at least a portion of a sphere) that represents the panoramic model. The angle selection engine(s) can be further configured to triangulate the sphere (or at least a portion of the sphere) into a plurality of triangles, with the vertices of each triangle representing a key camera angle required for building the panoramic model. The angle selection engine(s) may provide key camera angles and/or other data.

An image projection engine may implement one or more automated agents configured to project images from the scan of the subject's teeth to form an initial panoramic model for each key camera angle. The image projection engine may receive images and camera position and/or orientation data from the intraoral scanner. In some implementations, the image projection engine is configured to form a two-dimensional grid of points that includes all the pixel positions needed to construct the panoramic model for a given key camera angle. In one implementation, a two-dimensional grid can be formed by dividing the center jaw line into equidistant segments, forming a line at each segment, and identifying the equidistant points on each line. The lines can be perpendicular to the center jaw line and to the each key camera angle. The point cloud of all camera positions and orientations recorded during the scan can be compared to the points on each line, and the image projection engine can be configured to select the physical camera locations most suitable, for example the camera with orientation closest to the key camera angle for each point of each line. The most suitable image for each point of the two-dimensional grid can be approximated with an orthographic camera to provide images for each of the points of each line, resulting in an initial panoramic model for each key camera angle. Alternatively, other images selection criteria may be employed. The image projection engine may provide the two-dimensional grid of points, the projected images, the initial panoramic model.

The image combining engine may implement one or more automated agents configured to register, deform, and/or blend the images of the initial panoramic model to create a final panoramic model for each key camera angle. In some implementations, the image combining engine is configured to register and/or deform the images in the initial panoramic model to match gradients at the boundaries of adjacent images. The image combining engine may be further configured to blend the resulting images to produce a final panoramic model for each key camera angle. Additionally, the image combining engine may be configured to render the final panoramic model to the user for a chosen key camera angle.

In embodiments, a panoramic image, model and/or view may be generated as described in U.S. Publication No. 2021/0068773, filed Sep. 10, 2020 and published Mar. 11, 2021, entitled “Dental Panoramic Views,” which is incorporated by reference herein in its entirety. Once the panoramic image is generated, points may be selected from the panoramic image (which may be a 2D image) and projected onto the 3D surface for measurement.

At block 330, processing logic may receive selection of a first point on the 2D image and a second point on the 2D image (or a second point on a second 2D image). At block 335, processing logic determines a corresponding first point on the 3D surface that corresponds to the selected first point and determines a corresponding second point on the 3D surface that corresponds to the selected second point. This may include projecting the selected first and second points onto the 3D surface in embodiments.

At block 338, processing logic measures a distance between the first and second points on the 3D surface. The measured distance is a distance in 3D space, and is therefore referred to as a 3D measurement.

As discussed above, in some embodiments one or more trained machine learning models may be used to segment 2D images and/or to select points on 2D images. One type of machine learning model that may be used to perform one or both of these asks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs). Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset. In high-dimensional settings, such as large images, this generalization is achieved when a sufficiently large and diverse training dataset is made available.

A training dataset containing hundreds, thousands, tens of thousands, hundreds of thousands or more intraoral scans, images and/or 3D models may be used for training machine learning model(s). In embodiments, up to millions of cases of patient dentition that may have underwent a prosthodontic procedure and/or an orthodontic procedure may be available for forming a training dataset, where each case may include various labels of one or more types of useful information. Each case may include, for example, data showing a 3D model, intraoral scans, height maps, color images, NIRI images, etc. of one or more dental sites, data showing pixel-level segmentation of the data (e.g., 3D model, intraoral scans, height maps, color images, NIRI images, etc.) into various dental classes (e.g., tooth, gingiva, moving tissue, saliva, blood, caries, etc.), data showing one or more assigned scan quality metric values for the data, movement data associated with the 3D scans, and so on. This data may be processed to generate one or multiple training datasets for training of one or more machine learning models.

To effectuate training, processing logic inputs the training dataset(s) into one or more untrained machine learning models. Prior to inputting a first input into a machine learning model, the machine learning model may be initialized. Processing logic trains the untrained machine learning model(s) based on the training dataset(s) to generate one or more trained machine learning models that perform various operations as set forth above.

Training may be performed by inputting one or more of the images into the machine learning model one at a time. Each input may include data from an image in a training data item from the training dataset. The training data item may include, for example, a 2D image and an associated probability map, segmentation labels, etc., which may be input into the machine learning model.

The machine learning model processes the input to generate an output. An artificial neural network includes an input layer that consists of values in a data point (e.g., intensity values and/or height values of pixels in a height map). The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer may be another hidden layer or an output layer. In either case, the nodes at the next layer receive the output values from the nodes at the previous layer, and each node applies weights to those values and then generates its own output value. This may be performed at each layer. A final layer is the output layer, where there is one node for each class, prediction and/or output that the machine learning model can produce.

Processing logic may then compare the determined output to a provided label (e.g., provided segmentation information). Processing logic determines an error (i.e., a positioning error) based on the differences between the output and the known correct labels. Processing logic adjusts weights of one or more nodes in the machine learning model based on the error. An error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

Once the model parameters have been optimized, model validation may be performed to determine whether the model has improved and to determine a current accuracy of the deep learning model. After one or more rounds of training, processing logic may determine whether a stopping criterion has been met. A stopping criterion may be a target level of accuracy, a target number of processed images from the training dataset, a target amount of change to parameters over one or more previous data points, a combination thereof and/or other criteria. In one embodiment, the stopping criteria is met when at least a minimum number of data points have been processed and at least a threshold accuracy is achieved. The threshold accuracy may be, for example, 70%, 80% or 90% accuracy. In one embodiment, the stopping criteria is met if accuracy of the machine learning model has stopped improving. If the stopping criterion has not been met, further training is performed. If the stopping criterion has been met, training may be complete. Once the machine learning model is trained, a reserved portion of the training dataset may be used to test the model.

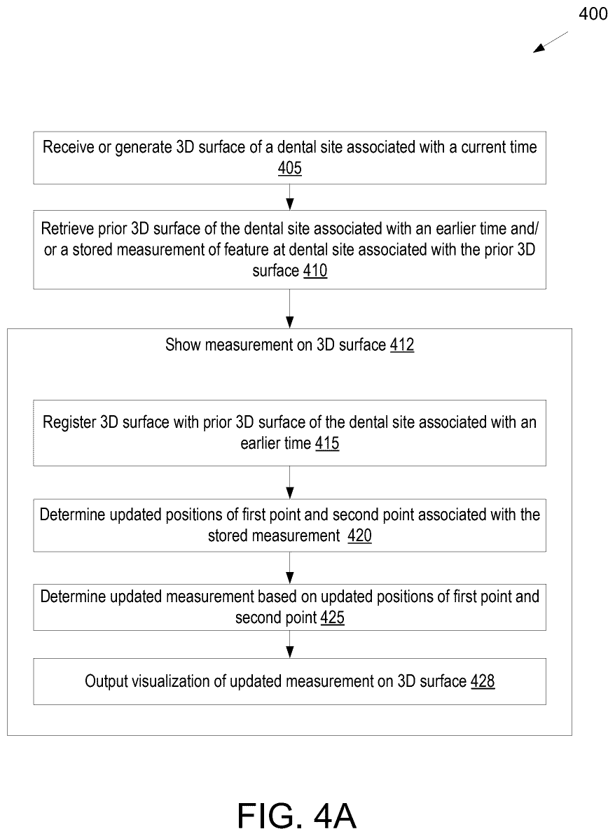

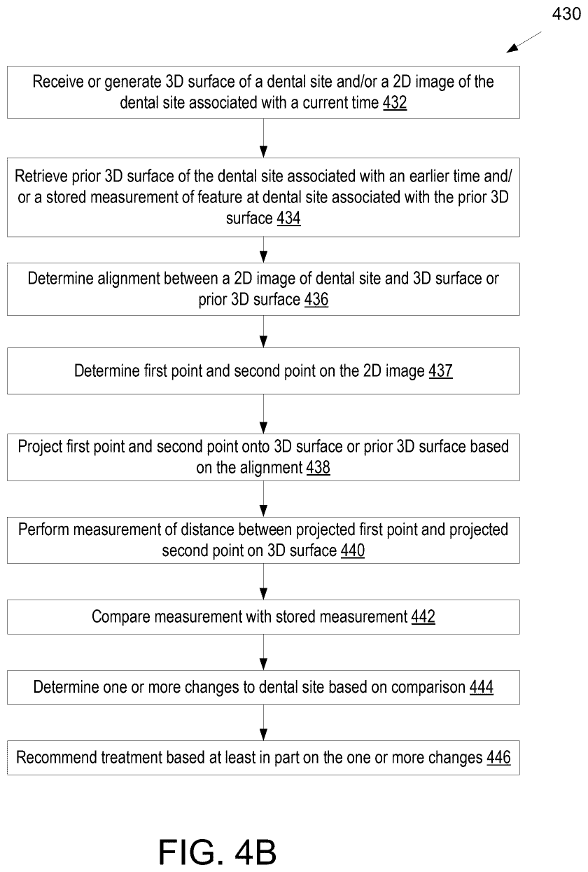

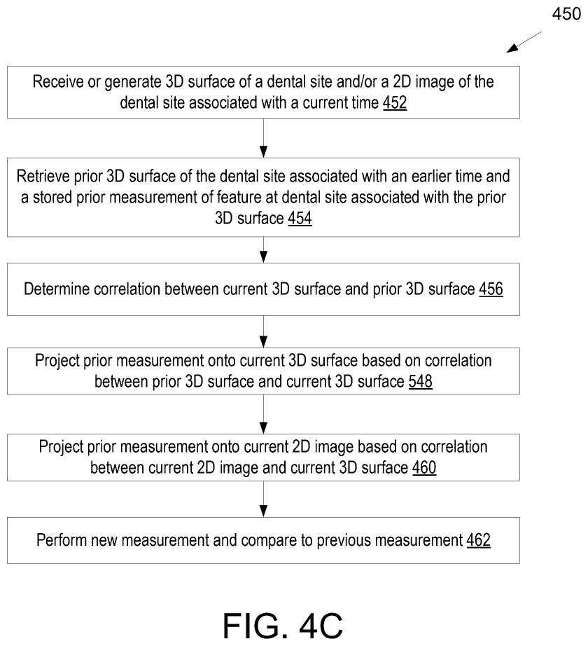

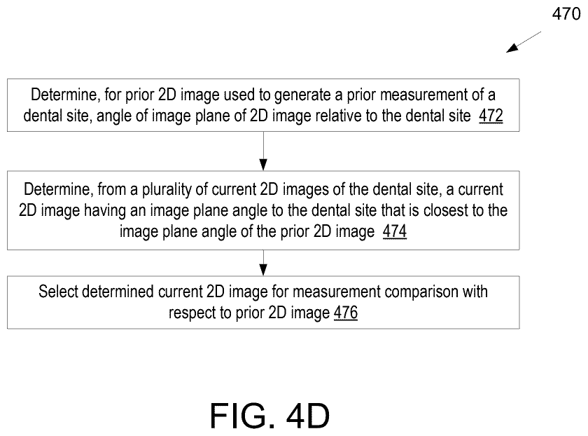

FIG. 4A illustrates a flow diagram for a method 400 of showing a previously generated measurement of a dental site on a new 3D surface of the dental site, in accordance with an embodiment. Method 400 may be performed, for example, during a current patient visit based on measurements made during one or more past patient visits. Alternatively, method 400 may be performed based on images captured by a patient device (e.g., at home), and the prior 3D surface may have been generated based on a patient visit.

At block 405 of method 400, processing logic receives or generates a 3D surface of a dental site that is associated with a current time. For example, processing logic may receive a 3D surface of a current condition of a patient's upper and/or lower dental arch. The 3D surface may have been generated based on images captured during a current or recent patient visit to a dentist. In another example, during a current patient visit a doctor or other dental professional may perform intraoral scanning of the patient's upper and/or lower dental arches, and may processing logic may generate the 3D surface from intraoral scans captured via the intraoral scanning. In another example, a patient may take one or more images of their dentition using a device such as a mobile phone, tablet computer, etc. The image(s) may be used to estimate a 3D surface of the patient's upper and/or lower dental arches (e.g., using a trained machine learning model such as a generative model).

At block 410, processing logic may retrieve a prior 3D surface of the dental site associated with an earlier time and/or a stored measurement of a feature (or AOI or region) at the dental site from a data store. The stored measurement may be associated with the prior 3D surface, and may have been generated, for example, by performing any of methods 200-350 based on a prior 2D image and 3D surface generated at the earlier time (e.g., during a prior patient visit to a doctor).

At block 412, processing logic shows the prior measurement on the current 3D surface. In one embodiment, showing the measurement on the current 3D surface includes at block 415 registering (e.g., finding a correlation between) the current 3D surface with the prior 3D surface. Alternatively, or additionally, a prior 2D image used to select points (e.g., a first point and a second point) from which the prior measurement was made may be registered with the current 3D surface. The registration may include determining, on a point-by-point basis, on a patch-level basis, on a feature basis, etc., correspondence between points on the current 3D surface and points on the prior 3D surface or the prior 2D image. The patient's dentition may have changed between the current time and the past time. Such change to the dentition may include, for example, worsening caries, tooth wear, gum erosion, tooth movement, and so on. The correspondence may map locations of points on the earlier 3D surface and/or 2D image to new locations for those points on the current 3D surface.

At block 420, processing logic determines updated positions for the first point and the second point used to generate the prior measurement. The updated locations for the first point and second point may be determined on the current 3D surface. At block 425, processing logic determines an updated measurement based on the updated positions for the first point and the second point on the 3D surface.

At block 428, processing logic may output a visualization of the updated measurement on the current 3D surface. Additionally, processing logic may output a visualization of the prior measurement on the current 3D surface. This may allow a viewer to compare the prior measurement to the current measurement. In some embodiments, processing logic projects the updated measurement onto the prior 2D image and/or onto a new 2D image having a same or similar imaging plane and/or position as the prior 2D image. The updated measurement and the prior measurement may then be displayed as overlays on the prior 2D image and/or new 2D image.

In some embodiments, processing logic compares the updated measurement to the prior measurement to determine changes to the feature, AOI, etc. between the current time and the prior time. The difference may be divided by a difference between the current time and the prior time to determine a rate of change of the measurement in embodiments. In some embodiments, processing logic may recommend treatment based at least in part on the one or more changes and/or rates of change.

FIG. 4B illustrates a flow diagram for a method 430 of tracking changes to a dental site over time, in accordance with an embodiment. Method 430 may be performed, for example, during a current patient visit based on measurements made during one or more past patient visits. Alternatively, method 430 may be performed based on images captured by a patient device (e.g., at home), and the prior 3D surface may have been generated based on a patient visit.

At block 432 of method 430, processing logic receives or generates a 3D surface of a dental site and/or one or more current 2D images of the dental site that is associated with a current time. For example, processing logic may receive a 3D surface of a current condition of a patient's upper and/or lower dental arch. The 3D surface may have been generated based on intraoral scans captured during a current or recent patient visit to a dentist. In another example, during a current patient visit a doctor or other dental professional may perform intraoral scanning of the patient's upper and/or lower dental arches, and processing logic may generate the 3D surface from intraoral scans captured via the intraoral scanning. In another example, a patient may take one or more images of their dentition using a device such as a mobile phone, tablet computer, etc. The image(s) may be used to estimate a 3D surface of the patient's upper and/or lower dental arches (e.g., using a trained machine learning model such as a generative model).

At block 434, processing logic may retrieve a prior 3D surface of the dental site associated with an earlier time and/or a stored measurement of a feature (or AOI or region) at the dental site from a data store. The stored measurement may be associated with the prior 3D surface, and may have been generated, for example, by performing any of methods 200-350 based on a prior 2D image and 3D surface generated at the earlier time (e.g., during a prior patient visit to a doctor).

At block 436, processing logic determines an alignment between one or more current 2D images of the dental site and the current 3D surface and/or the prior 3D surface.

At block 437, processing logic receives selection of a first point and a second point on the current 2D image. In one embodiment, processing logic automatically selects the first and second points based on first and second points selected in a prior 2D image used to generate the stored measurement. In one embodiment, processing logic first selects a current image from the one or more current images. This may include selecting a current 2D image that most closely aligns with the prior 2D image in embodiments (e.g., based on camera angle/orientation and position relative to the dental site). For example, processing logic may perform comparison between the prior 2D image and a plurality of current 2D images to identify a current 2D image that is most similar to the prior 2D image. Image data (e.g., pixels in the respective images), camera position, camera orientation, and/or other data may be used for comparison in embodiments.

At block 438, processing logic projects the first point and the second point from the current 2D image onto the current 3D surface or onto the prior 3D surface based on the determined alignment between the current 2D image and the current 3D surface or the prior 3D surface.

At block 440, processing logic performs a measurement of the distance between the projected first point and the projected second point on the current or prior 3D surface.

At block 442, processing logic may compare the current measurement with the prior (stored) measurement. At block 444, processing logic may determine one or more changes and/or one or more rates of change based on the comparison.

At block 446, processing logic may recommend treatment based at least in part on the one or more changes and/or rates of change.

FIG. 4C illustrates a flow diagram for another method 450 of tracking changes to a dental site over time, in accordance with an embodiment. Method 450 may be performed, for example, during a current patient visit based on measurements made during one or more past patient visits. Alternatively, method 450 may be performed based on images captured by a patient device (e.g., at home), and the prior 3D surface may have been generated based on a patient visit.

At block 452 of method 450, processing logic receives or generates a 3D surface of a dental site and a current 2D image of the dental site that is associated with a current time.

At block 454, processing logic may retrieve a prior 3D surface of the dental site associated with an earlier time and a stored prior measurement of a feature (or AOI or region) at the dental site from a data store. The stored measurement may be associated with the prior 3D surface, and may have been generated, for example, by performing any of methods 200-350 based on a prior 2D image and 3D surface generated at the earlier time (e.g., during a prior patient visit to a doctor).

At block 456, processing logic determines an alignment (also referred to as a correlation) between the current 3D surface and the prior 3D surface. The correlation may be performed, for example, in accordance with U.S. Pat. No. 10,499,793, issued Dec. 10, 2019, which is incorporated by reference herein in its entirety.

At block 458, processing logic projects the prior measurement from the prior 3D surface onto the current 3D surface based on the correlation between the prior 3D surface and the current 3D surface.

At block 460, processing logic may then project the prior measurement from the current 3D surface onto the current 2D image based on a correlation between the current 3D surface and the current 2D image. The prior measurement may therefore be shown on the current 3D image and/or the current 2D image.

In one embodiment, at block 462 processing logic performs one or more operations to generate a new measurement based on selection of new points on the current 2D image. The new points may be projected onto the current 3D shape to determine the measurement in 3D space and in units of physical measurement, and the measurement may be projected back onto the current 2D image in embodiments. The measurement may be performed, for example, in accordance with any of methods 200-350. The new measurement may then be compared to the prior measurement on the 3D surface and/or on the 2D image.

FIG. 4D illustrates a flow diagram for a method 470 of selecting a 2D image that best shows a feature of a dental site, in accordance with an embodiment. Method 470 may be performed, for example, to select a current 2D image to use for method 430.

At block 472 of method 470, processing logic determines, for a prior 2D image used to generate a prior measurement of a dental site (e.g., of a feature, AOI, region, etc. of the dental site), an angle of an image plane of the prior 2D image relative to the dental site. At block 474, processing logic determines, from a plurality of current 2D images of the dental site, a current 2D image having an image plane angle to the dental site that is closest to the image plane angle of the prior 2D image. Additionally, or alternatively, processing logic may select a subset of the current 2D images having an image plane angle to the dental site that corresponds to the image plane angle of the prior 2D image plus or minus a threshold difference. Processing logic may then compare image content (e.g., pixel values) of the prior 2D image to the subset of current 2D images. Processing logic may then select a current 2D image from the subset that most closely matches the prior 2D image.

At block 476, processing logic selects the determined current 2D image for a measurement comparison to the prior 2D image.

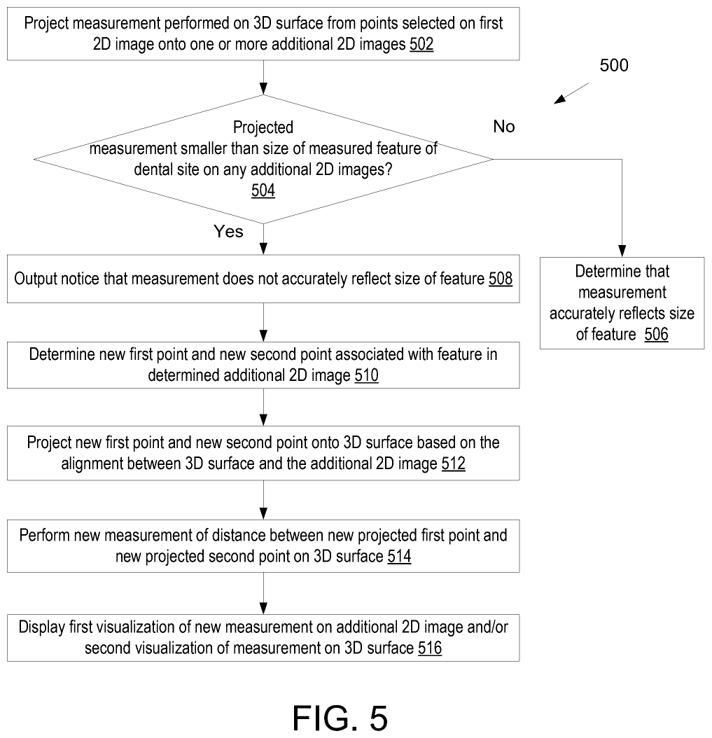

FIG. 5 illustrates a flow diagram for method 500 of updating a 3D measurement generated based on points selected in a 2D image, in accordance with an embodiment. Different 2D images of a dental site may show different portions, amounts, etc. of one or more areas of interest, features, regions, etc. of the dental site. In some embodiments, a doctor may select a 2D image for measurement that does not best show the feature, AOI, etc. being measured. Method 500 may be performed after a measurement has been made to determine whether another 2D image may be a better candidate for making the measurement.

At block 502 of method 500, processing logic projects a measurement performed on a 3D surface based on points selected on a first 2D image onto one or more additional 2D images. The measurement may have been performed, for example, according to any of methods 200-350. Projecting the measurement onto the additional 2D images may include projecting the points associated with the measurement from the 3D surface onto each of the additional 2D images based on a determined alignment (e.g., registration results) between the 3D surface and the respective 2D images. The measurement value may be projected together with the points in embodiments.

At block 504, processing logic determines whether the projected measurement is smaller than a size of a measured feature or AOI of the dental site in any of the additional 2D images. If the projected measurement is not smaller than the size of the feature/AOI in any additional 2D images, the method proceeds to block 506 and processing logic determines that the measurement accurately reflects a size of the feature/AOI. If the projected measurement is smaller than the size of the feature/AOI in one or more additional 2D images, the method proceeds to block 508 and processing logic may output a notice that the measurement does not accurately reflect the size of the feature/AOI. Additionally, or alternatively, at processing logic may perform one or more operations to determine a new measurement for the feature/AOI from the additional 2D image(s) at blocks 510-514.

In one embodiment, at block 504 processing logic processes the projected points and an additional 2D image using a trained machine learning model (e.g., a neural network). The trained machine learning model may output an indication as to whether the measurement accurately represents the AOI or feature of the dental site in the additional 2D image, or whether the AOI or feature is larger than the measurement value in the additional 2D image. Additionally, or alternatively, the trained machine learning model may select new points that represent extreme points (e.g., left-most and right-most points) on a feature or AOI being measured. In one embodiment, the trained machine learning model performs segmentation of the additional 2D image, and then selects updated points that are on a contour of an object that the projected points fall within. In one embodiment, a trained machine learning model performs segmentation of the additional 2D image, and image processing techniques (e.g., that do not use machine learning) are performed to determine an object associated with the points and then determine updated points on a contour of the object that are proximate to the original projected points. In one embodiment, a user manually selects new points on the additional 2D image for measurement using tools provided by a GUI.

In one embodiment, at block 510 processing logic determines a new first point and a new second point on an additional 2D image (e.g., automatically by processing the 2D image using a trained machine learning model or manually by a user engaging with the GUI). The new first point and new second point may be associated with a same feature/AOI as originally measured, but may represent different points on the feature/AOI (e.g., on a contour of the feature/AOI).

At block 512, processing logic projects the new first point and the new second point onto the 3D surface based on alignment between the 3D surface and the additional 2D image.

At block 514, processing logic performs a new measurement using the new projected first point and the new projected second point. The new measurement may be, for example, a distance between the new projected first point and the new projected second point.

At block 516, processing logic may display a first visualization of the new measurement on the 3D surface and/or a second visualization of the new measurement on the additional 2D image. In embodiments, the new measurement may be shown on the additional 2D image together with the original projected measurement on the additional 2D image.

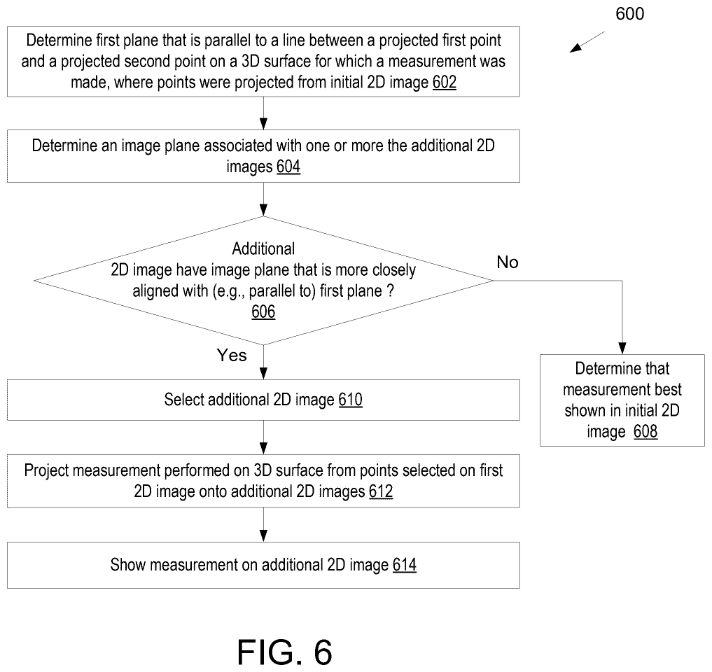

FIG. 6 illustrates a flow diagram for a method 600 of showing a measurement associated with a first 2D image on a second 2D image, in accordance with an embodiment. At block 602 of method 600, processing logic determines a first plane that is parallel to a line between a projected first point and a projected second point on a 3D surface for which a measurement was made, where the points were projected from an initial 2D image (e.g., in accordance with any of methods 200-350.

At block 604, processing logic determines, for each of the initial 2D image and one or more additional 2D images, an image plane associated with the respective 2D image. At block 606, processing logic determines whether any of the additional 2D images has an image plane that is more closely aligned (e.g., more close to parallel to) the first plane. If none of the additional 2D images has an image plane that is more closely aligned with the first plane, the method proceeds to block 608 and processing logic determines that the measurement is best shown in the initial 2D image. If at block 606 processing logic determines that an additional 2D image has an image plane that more closely aligns with the first plane, the method continues to block 610.

At block 610, processing logic selects the additional 2D image. At block 612, processing logic projects the measurement performed on the 3D surface based on points selected in the initial 2D image onto the selected additional 2D image. At block 614, processing logic may show the projected measurement on the additional 2D image (e.g., may show projected points projected from the 3D surface onto the additional 2D image and the measurement associated with those points). In some embodiments, processing logic additionally performs one or more operations of method 500. For example, processing logic may determine that the measurement does not accurately reflect a size of a measured feature/AOI of the dental site in the additional 2D image and may perform actions to select new points in the additional 2D image and generate a new measurement from the newly selected points.

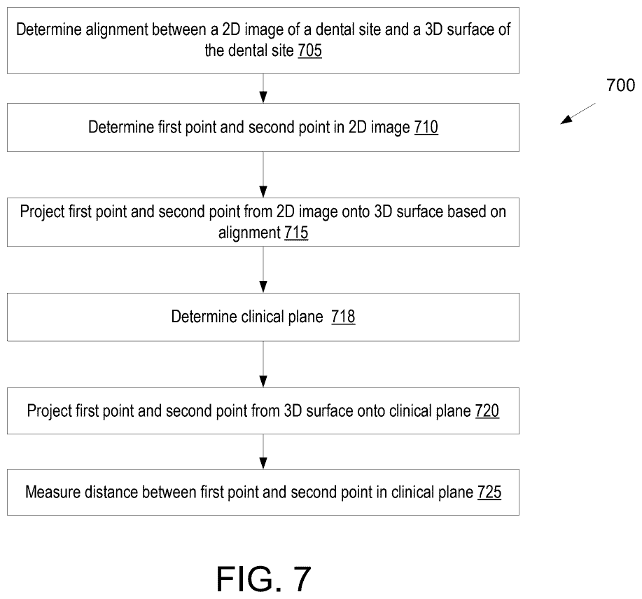

FIG. 7 illustrates a flow diagram for a method 700 of generating a measurement in a clinical plane, in accordance with an embodiment. At block 705 of method 700, processing logic determines an alignment between a 2D image of a dental site and a 3D surface of the dental site.

At block 710, processing logic determines a first point and a second point on the 2D image.

At block 715, processing logic projects the first point and the second point onto the 3D surface based on the alignment.

At block 718, processing logic determines a clinical plane associated with a measurement to be generated. The clinical plane may be, for example, an insertion plane, a midpalatal plane, an occlusal plane, or another clinical plane. In one embodiment, processing logic receives a selection of a clinical plane to be used to make a measurement based on user input. For example, a menu of clinical plane options may be presented in a user interface, and a user may select one of the presented clinical plane options (e.g., by clicking on an option). Alternatively, the clinical plane to be selected may be automatically determined based on contextual information, such as presence of a preparation tooth (e.g., an insertion plane may be automatically selected responsive to determining that selected points are on a preparation tooth).

The clinical plane may be a virtual plane in embodiments. Accordingly, the clinical plane may not correspond to a plane of any generated image. Alternatively, the clinical plane may correspond to a plane of a 2D image, and processing logic may determine an image having a plane that corresponds to the clinical plane (or that approximately corresponds to the clinical plane). An insertion plane may be a plane that is normal to an insertion path for a prosthodontic (e.g., a crown or bridge) that is to be inserted onto a preparation of a patient. In embodiments, an insertion plane may be automatically determined based on assessing an amount of undercuts of a preparation from a plurality of different positions, directions and/or angles, and selecting a plane for which an insertion path associated with the insertion plane has a minimum number of undercuts. Other techniques may also be used to determine the insertion plane. The occlusal plane may be a plane that is formed by the biting surfaces of the teeth. The occlusal plane may be a plane that passes through the incisal edges of the incisors and the tips of the occluding surfaces of the posterior teeth in embodiments. The midpalatal plane (also referred to as the medial palatal plane) is the vertical plane that divides the hard palate into two symmetrical halves. The midpalatal plane may run longitudinally down the center of the hard palate from the anterior to the posterior.

At block 720, processing logic projects (e.g., reprojects) the first point and the second point from the 3D surface onto the clinical plane.

At block 725, processing logic measures a distance between the first point and the second point (e.g., the reprojected first point and the reprojected second point) on the clinical plane. The distance may be measured in units of physical measurement, such as mm, inches, etc. in embodiments. In one example, the first and second point may be opposing points on a tooth (e.g., left most and right most point on the tooth in the 2D image), and the first and second points are projected onto the occlusal plane to measure a width of the tooth. In one example, the first and second point may be opposing points on a tooth, and the first and second points are projected onto the insertion plane to determine a width of the tooth along the insertion path.

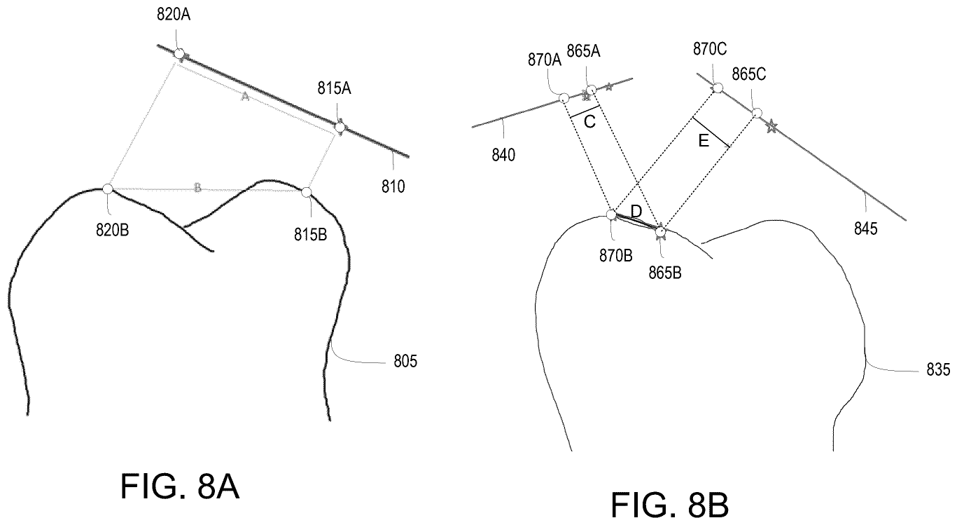

FIG. 8A illustrates a relationship between points on a 3D surface 805 and corresponding points on a 2D image 810 of the 3D surface, in accordance with an embodiment. As shown, the 2D image may be taken at an angle relative to the 3D surface, which in this example is a tooth. A first point 815A and a second point 820A may be selected in the image 810. A measurement A may be made between the first point 815A and the second point 820A. The measurement may be made in units of physical measurement (e.g., mm, inches, etc.). However, the measurement A is a measurement made in a 2D image plane of the image 810, and thus does not take into account depth information. As a result, the measurement A may not be an accurate measurement of the distance between the first point 815A and the second point 820A in the real world.

In embodiments, as discussed above, the first point 815A may be projected onto the 3D surface based on a registration between the 2D image 810 and the 3D surface 805 to result in first projected point 815B. Additionally, the second point 820A may be projected onto the 3D surface 805 based on the registration between the 2D image 810 and the 3D surface 805 to result in second projected point 820B. A measurement may be made between projected first point 815B and projected second point 820B in a 3D space of the 3D surface to generate measurement B. As shown, measurement B is greater than measurement A because it takes into account 3D information rather than only 2D information. Measurement B may be made in units of physical measurement. The measurement B may be projected back onto the 2D image 810 so that the physical units of measurement of measurement B are shown with respect to measurement A on the 2D image 810.

FIG. 8B illustrates a relationship between points on a 3D surface 835 and corresponding points on a first 2D image 840 and second 2D image 845 of the 3D surface, in accordance with an embodiment.

As shown, the first 2D image 840 may be taken at a first angle relative to the 3D surface 835, which in this example is a tooth. Additionally, second 2D image 845 may be taken at a second angle relative to the 3D surface 835. A first point 865A and a second point 870A may be selected in the first image 840. A measurement C may be made between the first point 865A and the second point 870A. The measurement C is a measurement made in a 2D image plane of the image 840, and thus does not take into account depth information. As a result, the measurement C may not be an accurate measurement of the distance between the first point 865A and the second point 870A in the real world.

In embodiments, as discussed above, the first point 865A may be projected onto the 3D surface based on a registration between the 2D image 840 and the 3D surface 835 to result in first projected point 865B. Additionally, the second point 870A may be projected onto the 3D surface 835 based on the registration between the 2D image 840 and the 3D surface 835 to result in second projected point 870B. A measurement may be made between projected first point 865B and projected second point 870B in a 3D space of the 3D surface to generate measurement D. As shown, measurement D is greater than measurement C because it takes into account 3D information rather than only 2D information. Measurement D may be made in units of physical measurement. The measurement D may be projected back onto the 2D image 840 so that the physical units of measurement of measurement D are shown with respect to measurement C on the 2D image 840.

In embodiments, image 845 may have been taken at an angle that better shows the separation between the first point 865B and second point 870B. Accordingly, based on the registration between 2D image 845 and 3D surface 835, the projected first point 865B and projected second point 870B may be projected onto the second 2D image 845 together with the measurement D. Alternatively, the projected first point 865B and projected second point 870B may be projected onto a virtual plane (e.g., that may not correspond to any image). A measurement E may be made between the projected first point 865C and projected second point 870C on the second 2D image 845 or in the virtual plane in units of physical measurement. The measurement E may not quite accurately reflect the true measurement D, but is closer to the true measurement than measurement C.

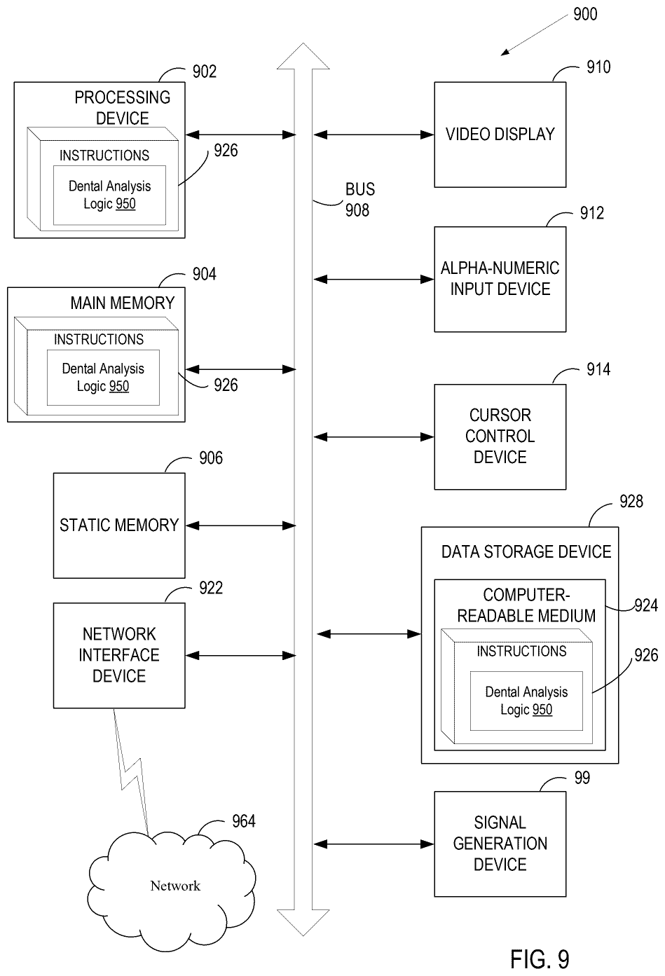

FIG. 9 illustrates a diagrammatic representation of a machine in the example form of a computing device 900 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The computing device 900 may correspond, for example, to computing device 105 of FIG. 1. The machine may operate in the capacity of a server or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The example computing device 900 includes a processing device 902, a main memory 904 (e.g., read-only memory (ROM), flash memory, dynamic random access memory (DRAM) such as synchronous DRAM (SDRAM), etc.), a static memory 906 (e.g., flash memory, static random access memory (SRAM), etc.), and a secondary memory (e.g., a data storage device 928), which communicate with each other via a bus 908.

Processing device 902 represents one or more general-purpose processors such as a microprocessor, central processing unit, or the like. More particularly, the processing device 902 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. Processing device 902 is configured to execute the processing logic (instructions 926) for performing operations and steps discussed herein.

The computing device 900 may further include a network interface device 922 for communicating with a network 964. The computing device 900 also may include a video display unit 910 (e.g., a liquid crystal display (LCD) or a cathode ray tube (CRT)), an alphanumeric input device 912 (e.g., a keyboard), a cursor control device 914 (e.g., a mouse), and a signal generation device 920 (e.g., a speaker).

The data storage device 928 may include a machine-readable storage medium (or more specifically a non-transitory computer-readable storage medium) 924 on which is stored one or more sets of instructions 926 embodying any one or more of the methodologies or functions described herein, such as instructions for dental analysis logic 950. A non-transitory storage medium refers to a storage medium other than a carrier wave. The instructions 926 may also reside, completely or at least partially, within the main memory 904 and/or within the processing device 902 during execution thereof by the computer device 900, the main memory 904 and the processing device 902 also constituting computer-readable storage media.

The computer-readable storage medium 924 may also be used to store dental analysis logic 950, which may include one or more machine learning modules, and which may perform the operations described herein above. The computer readable storage medium 924 may also store a software library containing methods for the dental analysis logic 950. While the computer-readable storage medium 924 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium other than a carrier wave that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

The following exemplary embodiments are now described.

Embodiment 1: A method comprising: determining an alignment between a two-dimensional (2D) image of a dental site and a three-dimensional (3D) surface of the dental site; determining a first point and a second point on the 2D image; projecting the first point and the second point onto the 3D surface based on the alignment between the 2D image and the 3D surface; performing a measurement of a distance between the projected first point and the projected second point on the 3D surface; and displaying at least one of a) a first visualization of the measurement on the 2D image or b) a second visualization of the measurement on the 3D surface.

Embodiment 2: The method of embodiment 1, further comprising: receiving a plurality of intraoral scans of the dental site generated by an intraoral scanner; and generating the 3D surface of the dental site based at least in part on the plurality of intraoral scans; wherein determining the alignment between the 2D image and the 3D surface comprises determining a correspondence between points on the 3D surface and points in the 2D image.

Embodiment 3: The method of embodiment 1 or 2, further comprising: performing a comparison of the measurement to one or more measurement criteria; and determining at least one of an existence of or a severity of an oral condition based on a result of the comparison.

Embodiment 4: The method of embodiments 1-3, wherein the measurement indicates at least one of a caries size, a tooth size, a spacing between teeth, a tumor size, a lesion size, an amount of gingival recession, a tooth width, or an amount that a tooth has erupted.

Embodiment 5: The method of embodiments 1-4, further comprising storing the measurement in a patient record.

Embodiment 6: The method of embodiments 1-5, wherein the 2D image and the 3D surface are associated with a first time, the method further comprising: receiving a second 3D surface of the dental site associated with a second time; performing registration of the second 3D surface of the dental site with the 3D surface of the dental site; determining updated positions of the projected first point and the projected second point on the second 3D surface based on the registration; and determining an updated measurement between the updated positions of the projected first point and the projected second point.

Embodiment 7: The method of embodiments 1-6, wherein the 2D image and the 3D surface are associated with a first time, the method further comprising: receiving a second 3D surface of the dental site associated with a second time; and showing the measurement on the second 3D surface of the dental site.

Embodiment 8: The method of embodiments 1-7, wherein the 2D image and the 3D surface are associated with a first time, the method further comprising: receiving at least one of a second 3D surface of the dental site or a second 2D image of the dental site associated with a second time; determining an alignment between the second 2D image of the dental site and the 3D surface of the dental site or the second 3D surface of the dental site; determining a third point and a fourth point in the second 2D image; projecting the third point and the fourth point onto the 3D surface or the second 3D surface based on the alignment between the second 2D image and the 3D surface or the second 3D surface; performing a second measurement of a second distance between the projected third point and the projected fourth point on the 3D surface or the second 3D surface; performing a comparison of the second measurement to the measurement; and determining one or more changes to the dental site based on the comparison of the second measurement to the measurement.

Embodiment 9: The method of embodiment 8, further comprising recommending a treatment based at least in part on the one or more changes.

Embodiment 10: The method of embodiments 8-9, further comprising: determining an angle of an image plane of the 2D image relative to the dental site; determining, from a plurality of additional 2D images associated with the second time, that a second angle of a second image plane of the second 2D image is closest to the angle of the 2D image; and selecting the second 2D image from the plurality of additional 2D images.

Embodiment 11: The method of embodiments 1-10, wherein the 2D image is a 2D color image.

Embodiment 12: The method of embodiments 1-10, wherein the 2D image is a 2D near infrared (NIR) image.

Embodiment 13: The method of embodiments 1-12, wherein determining the first point and the second point in the 2D image comprises: receiving a first user selection of the first point via a graphical user interface; and receiving a second user selection of the second point via the graphical user interface.

Embodiment 14: The method of embodiments 1-13, wherein determining the first point and the second point in the 2D image comprises: processing the 2D image using a trained machine learning model, wherein the trained machine learning model generates an output comprising a selection of the first point and the second point.

Embodiment 15: The method of embodiments 1-14, wherein the measurement is for a feature of the dental site, the method further comprising: projecting the measurement onto one or more additional 2D images of the dental site; determining that the projected measurement on an additional 2D image of the one or more additional 2D images is smaller than a size of the feature in the additional 2D image; and outputting a notice that the measurement does not accurately reflect the size of the feature.

Embodiment 16: The method of embodiment 15, further comprising: determining a third point and a fourth point each associated with the feature of the dental site in the additional 2D image; projecting the third point and the fourth point onto the 3D surface; performing a new measurement of a distance between the projected third point and the projected fourth point on the 3D surface; and displaying at least one of a) a third visualization of the new measurement on the additional 2D image or b) a fourth visualization of the new measurement on the 3D surface.

Embodiment 17: The method of embodiments 1-16, further comprising: determining a first plane that is parallel to a line between the projected first point and the projected second point on the 3D surface; determining, for each additional 2D image of one or more additional 2D images, an image plane associated with the additional 2D image; and selecting an additional 2D image of the one or more 2D images having an image plane that is closest to being parallel to the first plane.

Embodiment 18: The method of embodiment 17, further comprising: displaying the selected additional 2D image; and showing the measurement on the additional 2D image.

Embodiment 19: The method of embodiments 1-18, further comprising: determining a clinical plane; reprojecting the projected first point and the projected second point from the 3D surface onto the clinical plane; and measuring a distance between the reprojected first point and the reprojected second point in the clinical plane.

Embodiment 20: The method of embodiment 19, wherein the clinical plane is a virtual plane.

Embodiment 21: The method of embodiment 19, wherein the clinical plane is one of an insertion plane, an occlusal plane, or a midpalatal plane.

Embodiment 22: A non-transitory computer readable medium comprising instructions that, when executed by a processing device, cause the processing device to perform the method of any of embodiments 1-21.

Embodiment 23: An intraoral scanning system, comprising: an intraoral scanner configured to generate the 2D image and a plurality of intraoral scans usable to generate the 3D surface; and a computing device configured to: receive the 2D image and the plurality of intraoral scans; generate the 3D surface from the plurality of intraoral scans; and perform the method of any of embodiments 1-21.

Embodiment 24: A method comprising: determining a first alignment between a first two-dimensional (2D) image of a dental site and a three-dimensional (3D) surface of the dental site; determining a second alignment between a second two-dimensional (2D) image of the dental site and the 3D surface of the dental site; determining a first point in the first 2D image; projecting the first point onto the 3D surface based on the first alignment; determining a second point in the second 2D image; projecting the second point onto the 3D surface based on the second alignment; performing a measurement of a distance between the projected first point and the projected second point on the 3D surface; and displaying at least one of a) a first visualization of the measurement on the first 2D image, b) a second visualization of the measurement on the second 2D image, or c) a third visualization of the measurement on the 3D surface.

Embodiment 25: The method of embodiment 24, wherein the first 2D image and the second 2D images are both color 2D images or are both near infrared 2D images.

Embodiment 26: The method of embodiments 24-25, wherein the first 2D image is a color 2D image and the second 2D image is a near infrared 2D image.

Embodiment 27: The method of embodiments 24-26, wherein the first 2D image is generated from a first perspective relative to the dental site and the second 2D image is generated from a second perspective relative to the dental site.

Embodiment 28: The method of embodiments 24-27, wherein the first point is not visible in the second

2D image.

Embodiment 29: A non-transitory computer readable medium comprising instructions that, when executed by a processing device, cause the processing device to perform the method of any of embodiments 24-28.

Embodiment 30: An intraoral scanning system, comprising: an intraoral scanner configured to generate the first 2D image, the second 2D image, and a plurality of intraoral scans usable to generate the 3D surface; and a computing device configured to: receive the first 2D image, the second 2D image, and the plurality of intraoral scans; generate the 3D surface from the plurality of intraoral scans; and perform the method of any of embodiments 24-28.

It is to be understood that the above description is intended to be illustrative, and not restrictive. Many other embodiments will be apparent upon reading and understanding the above description. Although embodiments of the present disclosure have been described with reference to specific example embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A system comprising:
an intraoral scanner configured to generate intraoral scan data comprising at least one of a plurality of intraoral scans of a dental site or a plurality of two-dimensional (2D) images of the dental site; and
a computing device configured to:
determine an alignment between a two 2D image of the plurality of 2D images and a three-dimensional (3D) surface of the dental site;
determine a first point and a second point on the 2D image;
project the first point and the second point onto the 3D surface based on the alignment between the 2D image and the 3D surface;
perform a measurement of a distance between the projected first point and the projected second point on the 3D surface; and
display at least one of a) a first visualization of the measurement on the 2D image or b) a second visualization of the measurement on the 3D surface.

2. The system of claim 1, wherein the computing device is further configured to:
generate the 3D surface of the dental site based at least in part on the plurality of intraoral scans;
wherein determining the alignment between the 2D image and the 3D surface comprises determining a correspondence between points on the 3D surface and points in the 2D image.

3. The system of claim 1, wherein the computing device is further configured to:
perform a comparison of the measurement to one or more measurement criteria; and
determine at least one of an existence of or a severity of an oral condition based on a result of the comparison.

4. The system of claim 1, wherein the measurement indicates at least one of a caries size, a tooth size, a spacing between teeth, a tumor size, a lesion size, an amount of gingival recession, a tooth width, or an amount that a tooth has erupted.

5. The system of claim 1, wherein the 2D image and the 3D surface are associated with a first time, wherein the computing device is further configured to:
receive a second 3D surface of the dental site associated with a second time;
perform registration of the second 3D surface of the dental site with the 3D surface of the dental site;
determine updated positions of the projected first point and the projected second point on the second 3D surface based on the registration; and
determine an updated measurement between the updated positions of the projected first point and the projected second point.

6. The system of claim 1, wherein the 2D image and the 3D surface are associated with a first time, and wherein the computing device is further configured to:
receive a second 3D surface of the dental site associated with a second time; and
show the measurement on the second 3D surface of the dental site.

7. The system of claim 1, wherein the 2D image and the 3D surface are associated with a first time, and wherein the computing device is further configured to:
receive at least one of a second 3D surface of the dental site or a second 2D image of the dental site associated with a second time;
determine an alignment between the second 2D image of the dental site and the 3D surface of the dental site or the second 3D surface of the dental site;
determine a third point and a fourth point in the second 2D image;
project the third point and the fourth point onto the 3D surface or the second 3D surface based on the alignment between the second 2D image and the 3D surface or the second 3D surface;
perform a second measurement of a second distance between the projected third point and the projected fourth point on the 3D surface or the second 3D surface;
perform a comparison of the second measurement to the measurement; and
determine one or more changes to the dental site based on the comparison of the second measurement to the measurement.

8. The system of claim 7, wherein the computing device is further configured to:
determine an angle of an image plane of the 2D image relative to the dental site;
determine, from a plurality of additional 2D images associated with the second time, that a second angle of a second image plane of the second 2D image is closest to the angle of the 2D image; and
select the second 2D image from the plurality of additional 2D images.

9. The system of claim 1, wherein determining the first point and the second point in the 2D image comprises:
receiving a first user selection of the first point via a graphical user interface; and
receiving a second user selection of the second point via the graphical user interface.

10. The system of claim 1, wherein determining the first point and the second point in the 2D image comprises:
processing the 2D image using a trained machine learning model, wherein the trained machine learning model generates an output comprising a selection of the first point and the second point.

11. The system of claim 1, wherein the measurement is for a feature of the dental site, and wherein the computing device is further configured to:
project the measurement onto one or more additional 2D images of the dental site;
determine that the projected measurement on an additional 2D image of the one or more additional 2D images is smaller than a size of the feature in the additional 2D image; and
output a notice that the measurement does not accurately reflect the size of the feature.

12. The system of claim 1, wherein the computing device is further configured to:
determine a first plane that is parallel to a line between the projected first point and the projected second point on the 3D surface;
determine, for each additional 2D image of one or more additional 2D images, an image plane associated with the additional 2D image;
select an additional 2D image of the one or more additional 2D images having an image plane that is closest to being parallel to the first plane;
display the selected additional 2D image; and
show the measurement on the additional 2D image.

13. The system of claim 1, wherein the computing device is further configured to:
determine a clinical plane;
reproject the projected first point and the projected second point from the 3D surface onto the clinical plane; and
measure a distance between the reprojected first point and the reprojected second point in the clinical plane.

14. A system comprising:
an intraoral scanner configured to generate intraoral scan data comprising a plurality of intraoral scans of a dental site and a plurality of two-dimensional (2D) images of the dental site; and
a computing device configured to:
generate a three-dimensional (3D) surface from the plurality of intraoral scans;
determine a first alignment between a first 2D image of the plurality of 2D images and the 3D surface of the dental site;
determine a second alignment between a second 2D image of the plurality of 2D images and the 3D surface of the dental site;
determine a first point in the first 2D image;
project the first point onto the 3D surface based on the first alignment;
determine a second point in the second 2D image;
project the second point onto the 3D surface based on the second alignment;
perform a measurement of a distance between the projected first point and the projected second point on the 3D surface; and
display at least one of a) a first visualization of the measurement on the first 2D image, b) a second visualization of the measurement on the second 2D image, or c) a third visualization of the measurement on the 3D surface.

15. The system of claim 14, wherein the first 2D image and the second 2D image are both color 2D images or are both near infrared 2D images.

16. The system of claim 14, wherein the first 2D image is a color 2D image and the second 2D image is a near infrared 2D image.

17. The system of claim 14, wherein the first 2D image is generated from a first perspective relative to the dental site and the second 2D image is generated from a second perspective relative to the dental site.

18. The system of claim 14, wherein the first point is not visible in the second 2D image.

19. A non-transitory computer readable medium comprising instructions that, when executed by a processing device, cause the processing device to perform operations comprising:
determining an alignment between a two-dimensional (2D) image of a dental site and a three-dimensional (3D) surface of the dental site;
determining a first point and a second point on the 2D image;
projecting the first point and the second point onto the 3D surface based on the alignment between the 2D image and the 3D surface;
performing a measurement of a distance between the projected first point and the projected second point on the 3D surface; and
displaying at least one of a) a first visualization of the measurement on the 2D image or b) a second visualization of the measurement on the 3D surface.

20. The non-transitory computer readable medium of claim 19, the operations further comprising:
performing a comparison of the measurement to one or more measurement criteria; and
determining at least one of an existence of or a severity of an oral condition based on a result of the comparison, wherein the measurement indicates at least one of a caries size, a tooth size, a spacing between teeth, a tumor size, a lesion size, an amount of gingival recession, a tooth width, or an amount that a tooth has erupted.
